SEQUENCE LISTING (19 sequences)

SEQ ID NO: 1 - protein, 297 aa, artificial sequence
  Synthesized sequence from Paenibacillus sp. A1
MATGFYVSGNKLYDSTGKPFVMRGVNHGHSWFKNDLNTAIPAIAKTGANTVRIVLSNGSLYTKDDLNAVKNIINVVNQNKMIAVLEVHDATGKDDYNSLDAAVNYWISIKEALIGKEDRVIVNIANEWYGTWNGSAWADGYKKAIPKLRNAGIKNTLIVDAAGWGQFPQSIVDYGQSVFAADSQKNTVFSIHMYEYAGKDAATVKANMENVLNKGLALIIGEFGGYHTNGDVDEYAIMRYGQEKGVGWLAWSWYGNSSGLNYLDMATGPNGSLTSFGNTVVNDTYGIKNTSQKAGIF

SEQ ID NO: 2 - protein, 485 aa, artificial sequence
  Synthesized sequence from Bacillus akibai
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK

SEQ ID NO: 3 - protein, 485 aa, artificial sequence
  Synthesized sequence from Bacillus halmapalus
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVKR

SEQ ID NO: 4 - protein, 485 aa, artificial sequence
  Synthesized sequence from Bacillus species
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGKQNDYLDHHNIIGWTREGNTAHPNSGLATIMSDGAGGSKWMFVGRNKAGQVWSDITGNRTGTVTINADGWGNFSVNGGSVSIWVNK

SEQ ID NO: 5 - protein, 483 aa, artificial sequence
  Synthesized sequence from Bacillus amyloliquefaciens
VNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGSKRMYAGLKNAGETWYDITGNRSDTVKIGSDGWGEFHVNDGSVSIYVQK

SEQ ID NO: 6 - protein, 483 aa, artificial sequence
  Synthesized sequence
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGPQHDYLDHPDVIGWTREGDSSHPKSGLATLITDGPGGSKRMYAGLKNAGETWYDITGNRSDTVKIGSDGWGEFHVNDGSVSIYVQK

SEQ ID NO: 7 - protein, 483 aa, artificial sequence
  Synthesized sequence
ANLNGTLMQYFEWYMPNDGQHWRRLQNDSAYLAEHGITAVWIPPAYKGTSQADVGYGAYDLYDLGEFHQKGTVRTKYGTKGELQSAIKSLHSRDINVYGDVVINHKGGADATEDVTAVEVDPADRNRVISGEHRIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNSTVVSKHPLKAVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 8 - protein, 485 aa, artificial sequence
  Synthesized sequence
AATNGTMMQYFEWYVPNDGQQWNRLRTDAPYLSSVGITAVWTPPAYKGTSQADVGYGPYDLYDLGEFNQKGTVRTKYGTKGELKSAVNTLHSNGIQVYGDVVMNHKAGADYTENVTAVEVNPSNRNQETSGEYNIQAWTGFNFPGRGTTYSNFKWQWFHFDGTDWDQSRSLSRIFKFRGTGKAWDWEVSSENGNYDYLMYADIDYDHPDVVNEMKKWGVWYANEVGLDGYRLDAVKHIKFSFLKDWVDNARAATGKEMFTVGEYWQNDLGALNNYLAKVNYNQSLFDAPLHYNFYAASTGGGYYDMRNILNNTLVASNPTKAVTLVENHDTQPGQSLESTVQPWFKPLAYAFILTRSGGYPSVFYGDMYGTKGTTTREIPALKSKIEPLLKARKDYAYGTQRDYIDNPDVIGWTREGDSTKAKSGLATVITDGPGGSKRMYVGTSNAGEIWYDLTGNRTDKITIGSDGYATFPVNGGSVSVWVQQ

SEQ ID NO: 9 - protein, 480 aa, artificial sequence
  Synthesized sequence
ADNGTIMQYFEWYLPNDGAHWNRLNNDAQNLKNVGITAVWIPPAYKGGSSADVGYGVYDTYDLGEFNQKGTVRTKYGTKSELISAVNNLHAKGIAVYGDVVLNHRMNADATELVDAVEVDPNNRNVETTSTYQIQAWTQYDFPGRGNTYSSFKWRWYHFDGVDWDQSRGLNRIYKLRGDGKDWDWEVDSEYGNYDYLMGADLDFNHPDVVNETKTWGKWFVNTVNLDGVRLDAVKHIKFDFMRDWVNNVRSTTGKNLFAVGEYWHYDVNKLNSYITKTNGTMSLFDVPLHFRFYDASNGGGGYDMRNLLNNTLMSSNPMKAVTFVENHDTQPTQALQSTVQSWFKPLAYATILTREQGYPCVFYGDYYGTSDGKISSYKPIMDKLLNARKVYAYGTQRDYFDHPDIVGWTREGDAAHAGSGLATLITDGPGGSKWMYVGTSKAGQVWTDKTGNRSGTVTIDANGWGNFWVNGGSVSVWAK

SEQ ID NO: 10 - protein, 484 aa, artificial sequence
  Synthesized sequence
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAK

SEQ ID NO: 11 - protein, 309 aa, artificial sequence
  Synthesized sequence
ANSGFYVSGTTLYDANGNPFVMRGINHGHAWYKDQATTAIEGIANTGANTVRIVLSDGGQWTKDDIHTVRNLISLAEDNHLVAVLEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFTGGGSDGGTSP

SEQ ID NO: 12 - protein, 293 aa, Bacillus agaradhaerens
GFSVDGNTLYDANGQPFVMRGINHGHAWYKDTASTAIPAIAEQGANTIRIVLSDGGQWEKDDIDTIREVIELAEQNKMVAVVEVHDATGRDSRSDLNRAVDYWIEMKDALIGKEDTVIINIANEWYGSWDGSAWADGYIDVIPKLRDAGLTHTLMVDAAGWGQYPQSIHDYGQDVFNADPLKNTMFSIHMYEYAGGDANTVRSNIDRVIDQDLALVIGEFGHRHTDVDEDTILSYSEETGTGWLAWSWKGNSTSWDYLDLSEDWAGQHLTDWGNRIVHGADGLQETSKPSTVF

SEQ ID NO: 13 - protein, 299 aa, artificial sequence
  Synthesized sequence
ANSGFYVSGTTLYDANGNPFVMRGINHGHAWYKDQATTAIEGIANTGANTVRIVLSDGGQWTKDDIHTVRNLISLAEDNHLVAVPEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFT

SEQ ID NO: 14 - protein, 309 aa, artificial sequence
  Synthesized sequence
ANSGFYVSGTTLYDANGNPFVMRGINHGHAWYKDQATTAIEGIANTGANTVRIVLSDGGQWTKDDIHTVRNLISLAEDNHLVAVPEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFTGGGSDGGTSP

SEQ ID NO: 15 - protein, 299 aa, artificial sequence
  Synthesized sequence
NSGFYVSGTTLYDANGNPFVMRGINHGHAWYKDQATTAIEGIANTGANTVRIVLSDGGQWTKDDIQTVRNLISLAEDNNLVAVLEVHDATGYDSIASLNRAVDYWIEMRSALIGKEDTVIINIANEWFGSWDGAAWADGYKQAIPRLRNAGLNNTLMIDAAGWGQFPQSIHDYGREVFNADPQRNTMFSIHMYEYAGGNASQVRTNIDRVLNQDLALVIGEFGHRHTNGDVDESTIMSYSEQRGVGWLAWSWKGNGPEWEYLDLSNDWAGNNLTAWGNTIVNGPYGLRETSKLSTVFTG

SEQ ID NO: 16 - protein, 299 aa, artificial sequence
  Synthesized sequence
ASGFYVSGTILCDSTGNPFKIRGINHAHSWFKNDSATAMEAIAATGANTVRIVLSNGQQYAKDDANTVSNLLSLANQHKLIAILEVHDATGSDSVSALDHAVDYWIEMKNVLVGKEDRVLINIANEWYGTWDSNGWADGYKSAIPKLRNAGINHTLIVDAAGWGQYPQSIVDKGNEVFNSDPLRNTIFSIHMYEYAGGNADMVRANIDQVLNKGLAVIIGEFGHYHTGGDVDETAIMSYTQQKGVGWLAWSWKGNGAEWLYLDLSYDWAGNHLTEWGETIVNGANGLKATSTRAPIFGN

SEQ ID NO: 17 - protein, 338 aa, Bacillus amyloliquefaciens
AQSVPYGVSQIKAPALHSQGYTGSNVKVAVIDSGIDSSHPDLKVAGGASMVPSETNPFQDNNSHGTHVAGTVAALNNSIGVLGVAPSASLYAVKVLGADGSGQYSWIINGIEWAIANNMDVINMSLGGPSGSAALKAAVDKAVASGVVVVAAAGNEGTSGSSSTVGYPGKYPSVIAVGAVDSSNQRASFSSVGPELDVMAPGVSIQSTLPGNKYGAYNGTSMASPHVAGAAALILSKHPNWTNTQVRSSLENTTTKLGDSFYYGKGLINVQAAAQKSFPEVVGKTVDQAREYFTLHYPQYDVYFLPEGSPVTLDLRYNRVKVFYNPGTNVVNHVPHVG

SEQ ID NO: 18 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 19 - protein, 274 aa, Bacillus amyloliquefaciens
AQTVPYGIPLIKADKVQAQGFKGANVKVAVLDTGIQASHPDLNVVGGASFVAGEAYNTDGNGHGTHVAGTVAALDNTTGVLGVAPSVSLYAVKVLNSSGSGSYSGIVSGIEWATTNGMDVINMSLGGASGSTAMKQAVDNAYARGVVVVAAAGNSGSSGNTNTIGYPAKYDSVIAVGAVDSNSNRASFSSVGAELEVMAPGAGVYSTYPTNTYATLNGTSMASPHVAGAAALILSKHPNLSASQVRNRLSSTATYLGSSFYYGKGLINVEAAAQ

(19) United States
(12) Patent Application Publication
(10) Pub. No.: US 2021/0403831 A1
(43) Pub. Date: Dec. 30, 2021

(54) LAUNDRY DETERGENT COMPOSITION

(71) Applicant: Danisco US Inc., Palo Alto, CA (US)

(72) Inventors: Arjen Hoekstra, Leiden (NL); Arjan Siebum, Leiden (NL); Ellen Van Meerkerk, Leiden (NL); Joop Van der Laan, Leiden (NL)

(21) Appl. No.: 17/479,416

(22) Filed: Sep. 20, 2021

Related U.S. Application Data
(63) Continuation of application No. 16/348,047, filed on May 7, 2019.
(60) Provisional application No. 62/418,720, filed on Nov. 7, 2016.

(51) Int. Cl. C11D 3/386; C11D 1/72; C11D 1/82; C11D 3/00

(52) U.S. Cl. CPC C11D 3/386; C11D 1/72; C11D 1/82; C12Y 302/01078; C11D 3/0036; C11D 3/38636; C11D 3/0031

(57) ABSTRACT

Disclosed herein is a laundry detergent composition comprising one or more low temperature enzyme that provides excellent cleaning under more environmentally friendly conditions. In particular, the low temperature enzyme(s) contained in the laundry detergent composition described herein provides excellent cleaning at lower temperatures and/or in shorter wash times than conventional laundry detergents. The lower wash temperature and/or shorter wash cycle conserves energy and/or water without sacrificing detergent performance.

This application is a Continuation of U.S. application Ser. No. 16/348,047, filed May 7, 2019 and claims the benefit of U.S. Provisional Application No. 62/418,720, filed Nov. 7, 2016, the entire content is herein incorporated by reference in its entirety.

Disclosed herein is a laundry detergent composition comprising one or more low temperature enzyme(s) that provides excellent cleaning under more environmentally friendly conditions. In particular, the low temperature enzyme(s) contained in the laundry detergent composition described herein provides excellent cleaning at lower temperatures and/or in shorter wash times than conventional laundry detergents. The lower wash temperature and/or shorter wash cycle conserves energy and/or water without sacrificing detergent performance.

Enzymes are commonly used in laundry detergent formulations to facilitate the removal of various food, body fluid, environmental, cosmetic, etc. stains from fabrics and textiles. The active lifestyles of a more environmentally conscience consumer continues to demand laundry detergents with more effective stain removal at lower wash temperatures and in shorter wash cycles than provided by currently available laundry detergents. For example, carbohydrases, such as, amylase and mannanase hydrolyze starch and gum based thickeners and/or stabilizing agents present in common food and/or cosmetic stains. These gum based thickeners and/or stabilizers can be more difficult to remove at low wash temperatures due to the gelating nature of such agents. To address the consumers' increasing demands for a more effective and eco-friendly laundry detergent composition, provided herein is a laundry detergent composition containing an enzymatic system with more effective cleaning at lower wash temperatures and/or shorter wash cycles than currently available laundry detergent compositions.

Disclosed herein is a laundry detergent composition comprising: (a) at least 0.5 or 1 ppm of one or more active low temperature mannanase; and (b) (i) at least 2 or 4 ppm of one or more active low temperature amylase, and/or (ii) at least 5 or 10 ppm of one or more active low temperature protease. Also disclosed herein is one or more active low temperature mannanase, one or more active low temperature amylase, and one or more active low temperature protease.

In one embodiment, the low temperature mannanase is a mannanase that demonstrates at least 1.2, 1.5, or 2 times the relative activity of a reference mannanse at (i) 16° C. when compared to the relative activity at 32° C., or (ii) 20° C. when compared to the relative activity at 40° C.; wherein the reference manannase is set forth as SEQ ID NO:16; and wherein the relative activity is the ratio of the activity of the mannanase and reference mannanase at (i) 16° C. and 32° C., or (ii) 20° C. and 40° C. In another embodiment, the low temperature amylase is an amylase that demonstrates at least 1.2, 1.5, or 2 times the relative activity of a reference amylase at (i) 16° C. when compared to the relative activity at 32° C., or (ii) 20° C. when compared to the relative activity at 40° C.; wherein the reference amylase is set forth as SEQ ID NO:7; and wherein the relative activity is the ratio of the activity of the amylase and reference amylase at (i) 16° C. and 32° C., or (ii) 20° C. and 40° C. In a still further embodiment, the low temperature protease is a subtilisin protease that demonstrates at least 1.2, 1.5, or 2 times the relative activity of a reference protease at (i) 16° C. when compared to the relative activity at 32° C., or (ii) 20° C. when compared to the relative activity at 40° C.; wherein the reference protease is set forth as SEQ ID NO:17, SEQ ID NO:18, or SEQ ID NO:19; and wherein the relative activity is the ratio of the activity of the subtilisin protease and reference protease at (i) 16° C. and 32° C., or (ii) 20° C. and 40° C. In an even still further embodiment, the low temperature mannanase works in synergy with the low temperature amylase and/or the low temperature protease to hydrolyze a stain and/or soil that is present on an item, such as, for example a fabric.

### DESCRIPTION OF THE DRAWINGS

FIG. 1 depicts a multiple sequence alignment using MUSCLE software of the mannanase catalytic domains of PspMan4 (SEQ ID NO:1), WO2015022428-0015 (SEQ ID NO:11), 2WHL_A (SEQ ID NO:12), U.S. Pat. No. 6,566,114-002 (residues 32-330)(SEQ ID NO:13), U.S. Pat. No. 6,566,114-002 (residues 32-340)(SEQ ID NO:14), and Bacillus sp. JAMB-602 (PDB entry 1WKY_A)(residues 6-314)(SEQ ID NO:15).

FIG. 2 provides an alignment of the mature amino acid sequence of B. lentus subtilisin GG36 (SEQ ID NO:18) and the mature amino acid sequence of B. amyloliquefaciens subtilisin BPN′ (SEQ ID NO:17).

The following terms are defined for clarity. Terms and abbreviations not defined should be accorded their ordinary meaning as used in the art. For example, technical and scientific terms not defined herein have the same meaning as commonly understood by one of ordinary skill in the art to which this disclosure pertains (See, e.g., Singleton and Sainsbury, Dictionary of Microbiology and Molecular Biology, 2d Ed., John Wiley and Sons, N Y 1994; and Hale and Marham, The Harper Collins Dictionary of Biology, Harper Perennial, N Y 1991).

The singular terms “a,” “an,” and “the” include the plural reference unless the context clearly indicates otherwise.

The terms “mannan endo-1,4-β-mannosidase,” “endo-1,4-β-mannanase,” “endo-β-1,4-mannase,” “β-mannanase B,” “β-1, 4-mannan 4-mannanohydrolase,” “endo-β-mannanase,” “β-D-mannanase,” “1,4-β-D-mannan mannanohydrolase,” or “endo-β-mannanase” (EC 3.2.1.78) refer to an enzyme capable of the random hydrolysis of 1,4-β-D-mannosidic linkages in mannans, galactomannans and glucomannans. Endo-1,4-β-mannanases are members of several families of glycosyl hydrolases, including GH26 and GH5. In particular, endo-β-mannanases constitute a group of polysaccharases that degrade mannans and denote enzymes that are capable of cleaving polyose chains containing mannose units (i.e., are capable of cleaving glycosidic bonds in mannans, glucomannans, galactomannans and galactogluco-mannans). The “endo-β-mannanases” described herein may possess additional enzymatic activities (e.g., endo-1,4-β-glucanase, 1,4-β-mannosidase, and cellodextrinase activities).

The terms “mannanase,” “mannosidic enzyme,” “mannolytic enzyme,” “mannanase enzyme,” “mannanase polypeptides,” or “mannanase proteins” refer to an enzyme, polypeptide, or protein that can degrade mannan. The mannanase enzyme may, for example, be an endo-β-mannanase, an exo-β-mannanase, or a glycosyl hydrolase. As used herein, mannanase activity may be determined according to any procedure known in the art (See, e.g., Lever, Anal. Biochem, 47:273, 1972; Eriksson and Winell, Acta Chem. Scand., (1968), 22:1924; U.S. Pat. No. 6,602,842; and WO 95/35362A1).

The term “mannans” refers to polysaccharides having a backbone composed of 3-1,4-linked mannose; “glucomannans” are polysaccharides having a backbone of more or less regularly alternating β-1,4 linked mannose and glucose; “galactomannans” and “galactoglucomannans” are mannans and glucomannans with alpha-1,6 linked galactose side-branches. These compounds may be acetylated. The degradation of galactomannans and galactoglucomannans is facilitated by full or partial removal of the galactose side-branches. Further, the degradation of the acetylated mannans, glucomannans, galactomannans and galactoglucomannans is facilitated by full or partial deacetylation. Acetyl groups can be removed by alkali or by mannan acetylesterases. The oligomers that are released from the mannanases or by a combination of mannanases and alpha-galactosidase and/or mannan acetyl esterases can be further degraded to release free maltose by β-mannosidase and/or β-glucosidase.

The terms “amylase” or “amylolytic enzyme” refer to an enzyme that is, among other things, capable of catalyzing the degradation of starch. α-amylases are hydrolases that cleave the α-D-(1→4) O-glycosidic linkages in starch. Generally, α-amylases (EC 3.2.1.1; α-D-(1→4)-glucan glucanohydrolase) are defined as endo-acting enzymes cleaving α-D-(1→4) O-glycosidic linkages within the starch molecule in a random fashion yielding polysaccharides containing three or more (1-4)-α-linked D-glucose units. In contrast, the exo-acting amylolytic enzymes, such as β-amylases (EC 3.2.1.2; α-D-(1→4)-glucan maltohydrolase) and some product-specific amylases like maltogenic α-amylase (EC 3.2.1.133) cleave the polysaccharide molecule from the non-reducing end of the substrate. β-amylases, α-glucosidases (EC 3.2.1.20; α-D-glucoside glucohydrolase), glucoamylase (EC 3.2.1.3; α-D-(1→4)-glucan glucohydrolase), and product-specific amylases like the maltotetraosidases (EC 3.2.1.60) and the maltohexaosidases (EC 3.2.1.98) can produce malto-oligosaccharides of a specific length or enriched syrups of specific maltooligosaccharides.

The term “starch” refers to any material comprised of the complex polysaccharide carbohydrates of plants, comprised of amylose and amylopectin with the formula (C6H10O5)x, wherein X can be any number. The term includes plant-based materials such as grains, cereal, grasses, tubers and roots, and more specifically materials obtained from wheat, barley, corn, rye, rice, sorghum, brans, cassava, millet, milo, potato, sweet potato, and tapioca. The term “starch” includes granular starch. The term “granular starch” refers to raw, i.e., uncooked starch, e.g., starch that has not been subject to gelatinization.

The term “protease” refers to an enzyme that has the ability to break down proteins and peptides. A protease has the ability to conduct “proteolysis,” by hydrolysis of peptide bonds that link amino acids together in a peptide or polypeptide chain forming the protein. This activity of a protease as a protein-digesting enzyme is referred to as “proteolytic activity.” Many well-known procedures exist for measuring proteolytic activity.

The term “subtilisin” refers to any member of the S8 serine protease family as described in MEROPS—The Peptidase Data base (Rawlings et al., MEROPS: the peptidase database, Nucl. Acids Res. 34 Database issue, D270-272 (2006)). As described therein, the peptidase family S8 contains the serine endopeptidase subtilisin and its homologues (Biochem. J. 290:205-218 (1993)). Many Bacillus species (Bacillus sp.) secrete large amounts of subtilisins.

The phrase “low temperature mannanase” is a mannanase that demonstrates at least 1.2, 1.5, or 2 times the relative activity of the reference mannanase at a low temperature when compared to the relative activity at a reference temperature. That is, a low temperature mannanase has a ratio of the relative activity of the test and reference mannanases at a low temperature to the relative activity of the test and reference mannanases at a reference temperature that is ≥1.2, 1.5, or 2. In one embodiment, the low temperature is selected from 16° C. and 20° C., and the reference temperature is selected from 32° C. and 40° C. In another embodiment, the reference mannanase is the mannanase of SEQ ID NO:16, which is commercially available under the tradename EFFECTENZ® M 1000 (DuPont). In yet another embodiment, the mannanase demonstrates at least 1.2, 1.5, or 2 times the relative activity of the reference mannanase at 16° C. when compared to the relative activity at 32° C. In yet a further embodiment, the mannanase demonstrates at least 1.2, 1.5, or 2 times the relative activity of the reference mannanase at 20° C. when compared to the relative activity at 40° C. Activity may be determined by the well-known standard mannanase assay(s) described herein below in Example 4.

The phrase “low temperature amylase” is an amylase that demonstrates at least 1.2, 1.5, or 2 times the relative activity of the reference amylase at a low temperature when compared to the relative activity at a reference temperature. That is, a low temperature amylase has a ratio of the relative activity of the test and reference amylases at a low temperature to the relative activity of the test and reference amylases at a reference temperature that is ≥1.2, 1.5, or 2. In one embodiment, the low temperature is selected from 16° C. and 20° C., and the reference temperature is selected from 32° C. and 40° C. In another embodiment, the reference amylase is the amylase of SEQ ID NO:7, which is commercially available under the tradename TERMAMYL® (Novozymes) or PURASTAR® ST 15000L (DuPont). In a further embodiment, the amylase demonstrates at least 1.2, 1.5, or 2 times relative activity of the reference amylase at 16° C. when compared to the relative activity at 32° C. In an even further embodiment, the amylase demonstrates at least 1.2, 1.5, or 2 times the relative activity of the reference amylase at 20° C. when compared to the relative activity at 40° C. Activity may be determined by a well-known standard amylase assay(s) described herein below in Example 1.

The phrase “low temperature protease” is a subtilisin protease that demonstrates at least 1.2, 1.5, or 2 times the relative activity of the reference protease at a low temperature when compared to the relative activity at a reference temperature. That is, a low temperature protease has a ratio of the relative activity of the test and reference proteases at a low temperature to the relative activity of the test and reference proteases at a reference temperature that is ≥1.2, 1.5, or 2. In one embodiment, the low temperature is selected from 16° C. and 20° C., and the reference temperature is selected from 32° C. and 40° C. In another embodiment, the reference protease is the wild-type subtilisin protease of Bacillus lentus known as GG36 (SEQ ID NO:18), which is commercially available under the tradenames SAVINASE® (Novozymes) or PURAFECT® (Dupont). In yet another embodiment, the reference protease is the wild-type subtilisin protease of Bacillus amyloliquefaciens known as BPN′ (SEQ ID NO:17). In a further embodiment, the reference protease is the wild-type subtilisin protease of Bacillus lichenformis (SEQ ID NO:19), which is commercially available under the tradenames ALCALASE® (Novozymes) and OPTIMASE® (DuPont). In a still further embodiment, the reference protease is SEQ ID NO:17, SEQ ID NO:18, or SEQ ID NO:19. In an even still further embodiment, the protease demonstrates at least 1.2, 1.5, or 2 times the relative activity of the reference protease at 16° C. when compared to the relative activity at 32° C. In an even yet still further embodiment, the protease demonstrates at least 1.2, 1.5, or 2 times the relative activity of the reference mannanase at 20° C. when compared to the relative activity at 40° C. Activity may be determined by the well-known standard protease assay(s) described herein below in Example 2 or 3.

The phrase “relative activity”, when used in the context of low temperature mannanase, low temperature protease, and low temperature amylase, refers to the ratio of the activities of the test and reference enzymes at the specified temperatures. Relative activity is determined by setting the activity of a reference enzyme to 100% at the specified reference temperature, and then using this set activity number to calculate the activity of the test enzyme at the reference temperature and the activity of the test enzyme and reference enzyme at the low temperature.

The term “surfactant” refers to any compound generally recognized in the art as having surface active qualities. Surfactants generally include anionic, cationic, nonionic, and zwitterionic compounds, which are further described, herein.

The “compact” form of the cleaning compositions herein is best reflected by density and, in terms of composition, by the amount of inorganic filler salt. Inorganic filler salts are conventional ingredients of detergent compositions in powder form. In conventional detergent compositions, the filler salts are present in substantial amounts, typically about 17 to about 35% by weight of the total composition. In contrast, in compact compositions, the filler salt is present in amounts not exceeding about 15% of the total composition. In some embodiments, the filler salt is present in amounts that do not exceed about 10%, or more preferably, about 5%, by weight of the composition. In some embodiments, the inorganic filler salts are selected from the alkali and alkaline-earth-metal salts of sulfates and chlorides. In some embodiments, a preferred filler salt is sodium sulfate.

The term “fabric” refers to, for example, woven, knit, and non-woven material, as well as staple fibers and filaments that can be converted to, for example, yarns and woven, knit, and non-woven fabrics. The term encompasses material made from natural, as well as synthetic (e.g., manufactured) fibers.

The term “polypeptide” refers to a molecule comprising a plurality of amino acids linked through peptide bonds. The terms “polypeptide,” “peptide,” and “protein” are used interchangeably. Proteins may optionally be modified (e.g., glycosylated, phosphorylated, acylated, farnesylated, prenylated, and sulfonated) to add functionality. Where such amino acid sequences exhibit activity, they may be referred to as an “enzyme”. The conventional one-letter or three-letter codes for amino acid residues are used, with amino acid sequences being presented in the standard amino-to-carboxy terminal orientation (i.e., N→C).

The terms “wild-type” and “parental”, with respect to a polypeptide, refer to a naturally-occurring polypeptide that does not include a man-made substitution, insertion, or deletion at one or more amino acid positions. Similarly, the terms “wild-type” and “parental”, with respect to a polynucleotide, refer to a naturally-occurring polynucleotide that does not include a man-made substitution, insertion, or deletion at one or more nucleosides. However, note that a polynucleotide encoding a wild-type or parental polypeptide is not limited to a naturally-occurring polynucleotide, and encompasses any polynucleotide encoding the wild-type or parental polypeptide.

The term “naturally-occurring” refers to anything (e.g., polypeptide or nucleic acid sequences) that is found in nature. Conversely, the term “non-naturally occurring” refers to anything that is not found in nature (e.g., recombinant nucleic acids and polypeptide sequences produced in the laboratory or modification of the wild-type sequence).

The term “reference”, with respect to a polypeptide, refers to a naturally-occurring polypeptide that does not include a man-made substitution, insertion, or deletion at one or more amino acid positions, as well as a naturally-occurring or synthetic polypeptide that includes one or more man-made substitutions, insertions, or deletions at one or more amino acid positions. Similarly, the term “reference”, with respect to a polynucleotide, refers to a naturally-occurring polynucleotide that does not include a man-made substitution, insertion, or deletion of one or more nucleosides, as well as a naturally-occurring or synthetic polynucleotide that includes one or more man-made substitutions, insertions, or deletions at one or more nucleosides. For example, a polynucleotide encoding a wild-type or parental polypeptide is not limited to a naturally-occurring polynucleotide, and encompasses any polynucleotide encoding the wild-type or parental polypeptide.

The term “versus” means compared to.

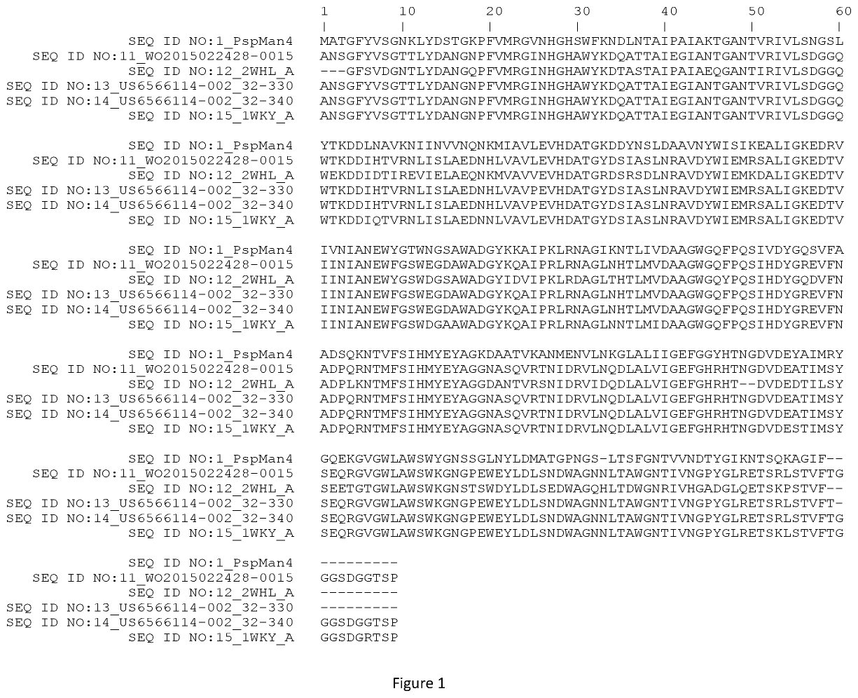

The term “variation(s)” when used in the phrases “one or more variations versus SEQ ID NO:1” or “one or more variations versus SEQ ID NO:19” encompass each amino acid that is different from the amino acid present at the corresponding position in SEQ ID NO:1 or SEQ ID NO:19, respectively. For example, the sequence of a mannanase variant of interest is aligned with SEQ ID NO:1 according to the alignment set forth in FIG. 1 and each position in the variant compared to SEQ ID NO:1 to identify the amino acids at each position that are different from the amino acid present at the corresponding positions in SEQ ID NO:1 and each amino acid that is different from the corresponding amino acid in SEQ ID NO:1 is a variation.

The amino acid substitutions described herein use one or more of following nomenclatures: position or starting amino acid:position:substituted amino acid(s). Reference to only a position encompasses any starting amino acid that may be present in a reference polypeptide, parent or benchmark molecule at that position and any amino acid with which such starting amino acid may be substituted (i.e., the substituted amino acid necessarily excludes the starting amino acid of such reference polypeptide, parent or benchmark molecule). Reference to a substituted amino acid may be further expressed as several substituted amino acids separated by a foreslash (“/”). For example, X130A/N-209-213 represents a three amino acid substitution combination, wherein X is any starting amino acid at position 130 that can be substituted with an alanine (A) or an asparagine (N); 209 represents a position where any starting amino acid can be substituted with an amino acid that is not the starting amino acid; and 213 represents a position where any starting amino acid can be substituted with an amino acid that is not the starting amino acid. By way of further example, S101F/G/H/T/V represents five possible substitutions at position 101, wherein the starting amino acid serine (S) can be substituted with a phenylalanine (F), glycine (G), histidine (H), threonine (T), or valine (V).

The one letter code “Z” identifies an insertion or deletion in a parent or reference amino acid sequence. For an insertion relative to the parent or reference sequence, the one letter code “Z” is on the left side of the position number and further includes a number (e.g., 0.01) before each amino acid being inserted therein to indicate the order of the insertions. For example, the insertion of a one amino acid, glutamine (Q), at position 298 would be depicted as “Z298.01Q”; the insertion of one amino acid, X (where X can be any amino acid) at position 298 would be depicted as “Z298.01X”; and the insertion of three amino acids alanine (A), serine (S) and tyrosine (Y) between position 87 and 88 would be depicted as “Z87.01A/Z87.02S/Z87.03Y”. For a deletion, the one letter code “Z” is on the right side of the position number. For example, the deletion of an alanine (A) from position 100 would be depicted as A100Z. A combination of some the above insertions and deletions would be depicted as: “G87S/Z87.01A/Z87.02S/Z87.03Y/A100Z”.

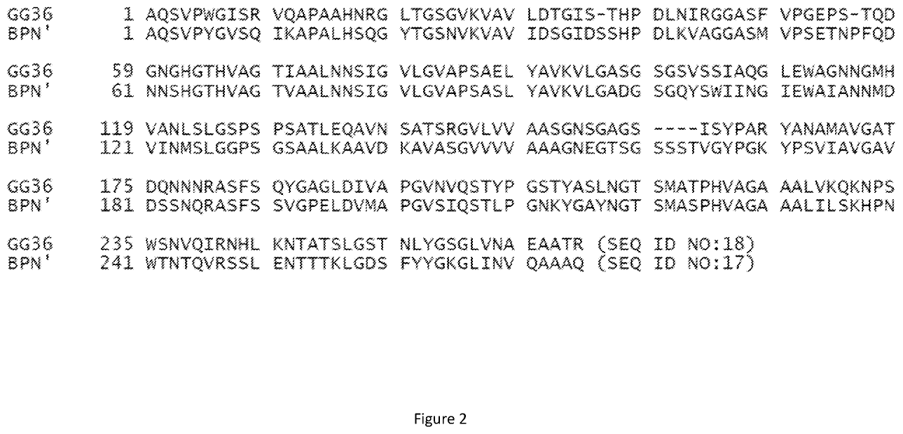

With regard to GG36 subtilisin protease variants (i.e., subtilisin protease variants of SEQ ID NO:18), the position of each identified amino acid residue in each GG36 variant is numbered by correspondence with the amino acid sequence of BPN′ (SEQ ID NO:17). For example, the amino acid sequence of a GG36 subtilisin protease variant described herein is aligned with the amino acid sequence of BPN′ in accordance with the alignment set forth in FIG. 2, and each amino acid residue in the amino acid sequence of the GG36 subtilisin protease variant that aligns with an amino acid residue in BPN′ is conveniently numbered by reference to the numerical position of the corresponding BPN′ amino acid residue.

The phrases “mannanase variant”, “amylase variant”, and “protease variant” refer to a polypeptide that is derived from a reference polypeptide by the substitution, addition, or deletion, of one or more amino acids, typically by recombinant DNA techniques. A variant may differ from a reference polypeptide by a small number of amino acid residues and may be defined by the level of primary amino acid sequence homology/identity with the reference polypeptide over the length of the catalytic domain. For example, a variant has at least 59%, 60%, 65%, 70%, 75%, 80%, 81%, 82%, 83%, 84%, 85%, 86%, 87%, 88%, 89%, 90%, 91%, 92%, 93%, 94%, 95%, 96%, 97%, 98%, 99% or 100% amino acid sequence identity with the amino acid sequence of the reference polypeptide.

Sequence identity may be determined using known programs such as BLAST, ALIGN, and CLUSTAL using standard parameters. (See, e.g., Altschul et al. [1990] J. Mol. Biol. 215:403-410; Henikoff et al. [1989] Proc. Natl. Acad. Sci. USA 89:10915; Karin et al. [1993] Proc. Natl. Acad. Sci. USA 90:5873; and Higgins et al. [1988] Gene 73:237-244). Software for performing BLAST analyses is publicly available through the National Center for Biotechnology Information (NCBI). Databases may also be searched using FASTA (Pearson et al. [1988] Proc. Natl. Acad. Sci. USA 85:2444-2448). One indication that two polypeptides are substantially identical is that the first polypeptide is immunologically cross-reactive with the second polypeptide. Typically, polypeptides that differ by conservative amino acid substitutions are immunologically cross-reactive. Thus, a polypeptide is substantially identical to a second polypeptide, for example, where the two peptides differ only by a conservative substitution. Another useful algorithm for comparison of multiple protein sequences is the MUSCLE program from Geneious software (Biomatters Ltd.) (Robert C. Edgar. MUSCLE: multiple sequence alignment with high accuracy and high throughput Nucl. Acids Res. (2004) 32 (5): 1792-1797).

The phrase “derived from” encompasses the phrases “originated from,” “obtained from,” “obtainable from,” “isolated from,” and “created from” and generally indicates that one specified material find its origin in another specified material or has features that can be described with reference to another specified material.

The phrases “substantially similar” and “substantially identical” in the context of at least two polypeptides means that the polypeptide comprises either a sequence that has at least about 90%, 91%, 92%, 93%, 94%, 95%, 96%, 97%, 98%, or 99% identity to a parent or reference sequence, or a sequence that includes amino acid substitutions, insertions, deletions, or modifications made only to circumvent the present description without adding functionality.

The term “recombinant” refers to genetic material (i.e., nucleic acids, the polypeptides they encode, and vectors and cells comprising such polynucleotides) that has been modified to alter its sequence or expression characteristics, such as by mutating the coding sequence to produce an altered polypeptide, fusing the coding sequence to that of another gene, placing a gene under the control of a different promoter, expressing a gene in a heterologous organism, expressing a gene at a decreased or elevated levels, expressing a gene conditionally or constitutively in manner different from its natural expression profile, and the like. Generally, recombinant nucleic acids, polypeptides, and cells based thereon, have been manipulated by man such that they are not identical to related nucleic acids, polypeptides, and cells found in nature.

The phrase “substantially-free of boron” refers to a detergent that contain trace amounts of boron, for example, less than about 1000 ppm (1 mg/kg or liter equals 1 ppm), less than about 100 ppm, less than about 50 ppm, less than about 10 ppm, or less than about 5 ppm, or less than about 1 ppm, perhaps from other compositions or detergent constituents.

Any headings used herein are provided for convenience and should not be construed as limitations. The description included under one heading may apply to the specification as a whole.

Variants, compositions and methods disclosed herein relate to one or more recombinant polypeptides comprising one or more insertions, substitutions or deletions, wherein such variants are generated through conventional molecular biology techniques (see, e.g., Sambrook et al, Molecular Cloning: Cold Spring Harbor Laboratory Press).

One embodiment is directed to a laundry detergent composition comprising (a) at least 0.5, 0.75, or 1 ppm of one or more active low temperature mannanase; and (b)(i) at least 2, 3, or 4 ppm of one or more active low temperature amylase, and/or (b)(ii) at least 5, 6, 7, 8, 9, or 10 ppm of one or more active low temperature protease. Another embodiment is directed to a laundry detergent composition comprising (a) at least 1 ppm of one or more active low temperature mannanase; and (b)(i) at least 4 ppm of one or more active low temperature amylase, and/or (b)(ii) at least 10 ppm of one or more active low temperature protease.

In one embodiment, the low temperature mannanase is a mannanase variant derived from a reference polypeptide that includes naturally occurring and recombinant mannanases within the GH5_8 sub family of mannanases (endo-1,4 β-mannosidases, EC 3.2.1.78). This GH5_8 sub family is more fully described in Aspeborg et al (2012), “Evolution, substrate specificity and subfamily classification of glycosyl hydrolase family 5 (GH5)”, BMC Evolutionary Biology, 12:186. Exemplary GH5_8 bacterial mannanases include, for example, NDL-Clade mannanases, such as, for example, PspMan4 (SEQ ID NO:1); Bac. sp.1WKY_A (BAD99527.1)(SEQ ID NO:15), B. agaradhaerens 2WHL_A (residues 30-330 of Q5YEX6)(SEQ ID NO:12), WO2015022428-0015(SEQ ID NO:11), residues 32-330 of U.S. Pat. No. 6,566,114-002 (SEQ ID NO:13), and residues 32-340 of U.S. Pat. No. 6,566,114-002 (SEQ ID NO:14). The NDL-Clade of mannanases is more fully described in WO2016007929. In a further embodiment, the low temperature mannanase is a mannanase variant derived from a reference polypeptide selected from SEQ ID NOs:1, 11, 12, 13, 14, and 15. In an even still further embodiment, the low temperature mannanase is a mannanase variant with at least 59%, 60%, 65%, 70%, 75%, 80%, 81%, 82%, 83%, 84%, 85%, 86%, 87%, 88%, 89%, 90%, 91%, 92%, 93%, 94%, 95%, 96%, 97%, 98%, or 99% amino acid sequence identity with the amino acid sequence of a reference polypeptide selected from SEQ ID NOs:1, 11, 12, 13, 14, and 15.

In one embodiment, the low temperature mannanase is selected from a variant described in U.S. Pat. No. 6,566,114, WO2015022428, WO2016007929, U.S. Provisional Patent Appl. No. 62/251,516, filed Nov. 5, 2015, and U.S. Provisional Patent Appl. Nos. 62/278,383 and 62/278,387, filed Jan. 13, 2016. In another embodiment, the low temperature mannanase is a mannanase variant, or a recombinant polypeptide or an active fragment thereof comprising an amino acid sequence comprising one, two, three, four, five, six, seven or more variations versus SEQ ID NO:1 at one, two, three, four, five, six, seven or more positions selected from: (i) 10, 19, 30, 38, 59, 60, 62, 63, 66, 67, 68, 70, 71, 74, 75, 78, 79, 80, 85, 97, 103, 129, 131, 135, 136, 143, 167, 168, 184, 213, 214, 225, 228, 235, 242, 244, 258, 259, 261, and 283; (ii) 19, 38, 67, 85, 97, 129, 143, 168, 184, 225, 228, 235, 244, 258, and 261; or (iii) 19, 38, 67, 85, 129, 168, 184, 225, 244, 258, and 261; with the proviso that one or more of said variations is non-naturally occurring; and wherein the amino acid positions of said mannanase variant or recombinant polypeptide or active fragment thereof are numbered by correspondence with the amino acid sequence of SEQ ID NO:1.

In another embodiment, the low temperature mannanase is a mannanase variant, or a recombinant polypeptide or an active fragment thereof comprising one, two, three, four, five, six, seven or more variations versus SEQ ID NO:1 selected from: (i) 10Q/T, 19E/V, 30T, 38E/I/L/M/Q/R/V, 59D/G/K/N/Q/T, 60F/M/V, 62E/I/Q/V, 63L, 66C/T/V, 67A/D/E/G/P/Q/S/V, 68L/M/R/S/W, 70R/V, 71D/H, 74E/C/Q/V, 75I, 78A/D/L/M, 79E/F/W, 80Q/T, 85L, 97E/L/P/Q, 103I, 129M, 131P, 135A/C/Q, 136E, 143Q/R, 167L/S/W/Y, 168A/E/G/L/M/S/T, 184D/F/H/L/M/P, 213E, 214C/Q, 225A/C/P/W, 228A/G/H/I/K/S/V/Y, 235G/I/L/Q/S/V, 242S/E, 244A/C/G/L/M/P/S, 258A/D/E/G/M/N/P/T, 259A/E/R/S/W, 261I/M/P/Q/R/S/T/V/W/Y, and 283G/H/T; (ii) 19E/V, 38E/I/L/M/Q/R/V, 67A/D/E/G/P/Q/S/V, 85L, 97E/L/P/Q, 129M, 143Q/R, 168A/E/G/L/M/S/T, 184D/F/H/L/M/P, 225A/C/P/W, 228A/G/H/I/K/S/V/Y, 235G/I/L/Q/S/V, 244A/C/G/L/M/P/S, 258A/D/E/G/M/N/P/T, and 261I/M/P/Q/R/S/T/V/W/Y; (iii) 19E/V, 38E/I/L/M/Q/R/V, 67A/D/E/G/P/Q/S/V, 85L, 129M, 168A/E/G/L/M/S/T, 184D/F/H/L/M/P, 225A/C/P/W, 244A/C/G/L/M/P/S, 258A/D/E/G/M/N/P/T, and 261I/M/P/Q/R/S/T/V/W/Y; or (iv) 19E, 30T, 38E, 59V, 60Q, 63R, 67D, 85L, 97D, 103I, 129M, 167Y, 168S, 184L, 225C, 228V, 235L, 244L, 258D, and 261R; with the proviso that one or more of said variations is non-naturally occurring; and wherein the amino acid positions of said mannanase variant or recombinant polypeptide or active fragment thereof are numbered by correspondence with the amino acid sequence of SEQ ID NO:1.

In yet another embodiment, the low temperature mannanase is a mannanase variant, or a recombinant polypeptide or an active fragment thereof comprising two, three, four, five, six, seven or more variations versus SEQ ID NO:1 selected from: (i) N/T10Q/T, P19E/V, A/S30T, T38E/I/L/M/Q/R/V, G/S59D/G/K/N/Q/T, L/Q60F/M/V, E/T62E/I/Q/V, K63R, I/L66C/T/V, D/H/N67A/D/E/G/P/Q/S/V, A/T68L/M/R/S/W, K/R70R/V, E/N71D/H, E/N/S74E/C/Q/V, L/V75I, D/Q78A/D/L/M, N79E/F/W, H/K80Q/T, P/V85L, A/N/S97E/L/P/Q, V103I, F/Y129M, S/T131P, D/S135A/C/Q, A136E, D/K/Q143Q/R, F/Y167L/S/W/Y, P168A/E/G/L/M/S/T, L/Q184D/F/H/L/M/P, D/N213E, K/Q214C/Q, G/H225A/C/P/W, T228A/G/H/I/K/S/V/Y, A/D/Y235G/I/L/Q/S/V, E/Q242S/E, K/R/Y244A/C/G/L/M/P/S, P/S/T258A/D/E/G/M/N/P/T, E/G/S259A/E/R/S/W, D/E/N261I/M/P/Q/R/S/T/V/W/Y, and D/G283G/H/T; (ii) P19E/V, T38E/I/L/M/Q/R/V, D/H/N67A/D/E/G/P/Q/S/V, P/V85L, A/N/S97E/L/P/Q, F/Y129M, D/K/Q143Q/R, P168A/E/G/L/M/S/T, L/Q184D/F/H/L/M/P, G/H225A/C/P/W, T228A/G/H/I/K/S/V/Y, A/D/Y235G/I/L/Q/S/V, K/R/Y244A/C/G/L/M/P/S, P/S/T258A/D/E/G/M/N/P/T, and D/E/N261I/M/P/Q/R/S/T/V/W/Y; (iii) P19E/V, T38E/I/L/M/Q/R/V, D/H/N67A/D/E/G/P/Q/S/V, P/V85L, F/Y129M, P168A/E/G/L/M/S/T, L/Q184D/F/H/L/M/P, G/H225A/C/P/W, K/R/Y244A/C/G/L/M/P/S, P/S/T258A/D/E/G/M/N/P/T, and D/E/N261I/M/P/Q/R/S/T/V/W/Y; or (iv) P19E, A/S30T, T38E, G/S59V, L60Q, K63R, H/N67D, P/V85L, A/N/S97D, V103I, F/Y129M, F167Y, P168S, Q184L, G/H225C, T228V, A/D/Y235L, K/R/Y244L, P/S/T258D, and D/E/N261R with the proviso that one or more of said variations is non-naturally occurring; and wherein the amino acid positions of said mannanase variant or recombinant polypeptide or active fragment thereof are numbered by correspondence with the amino acid sequence of SEQ ID NO:1.

In still yet an even further embodiment, the low temperature mannanase is a mannanase variant, or a recombinant polypeptide or an active fragment thereof comprising a combination of substitutions in SEQ ID NO:1 selected from P19E-T38E-N67D-N97D-Y129M-P168S-Q184L-K244L-S258D-N261R; N10T-P19E-G28S-S30T-T38E-N67D-N71D-N97D-Y129M-P168S-Q184L-G225C-Y235L-K244L-S258D-N261R-Z298.01Q; P19E-S30T-T38E-S59V-L60Q-K63R-N67D-N97D-V103I-Y129M-F167Y-Q184L-G225C-T228V-Y235L-K244L-S258D-N261R-Z298.01Q; N10T-P19E-S30T-T38E-S59V-L60Q-K63R-N67D-N97D-Y129M-K143Q-P168S-Q184L-G225C-T228V-Y235L-K244L-S258D-N261R-Z298.01Q; N10 T-P19E-S30 T-T38E-S59V-L60Q-K63R-N67D-N97D-Y129M-K143Q-P168S-Q184L-G225P-T228V-Y235L-K244L-S258D-N261R-Z298.01Q; N10T-P19E-S30T-T38E-S59V-L60Q-K63R-N67D-N71D-N97D-V103I-Y129M-K143Q-P168S-Q184L-G225P-T228V-Y235L-K244L-S258D-N261R-Z298.01Q; A2S-P19E-G28S-S30T-T38E-K63R-N67D-N71D-N74E-K93R-N97D-Y129M-N150T-P168S-Q184L-N213A-G225C-Y235L-K244L-S258D-N261Q-Z298.01Q; T3R-N10T-P19E-G28A-S30T-T38E-T62E-N67D-N71D-K93R-N97L-E111S-Y129M-D139M-P168S-Q184L-G225C-Y235L-K244L-S258D-N261Q-Z298.01Q; and N10 T-P19E-G28A-S30 T-T38E-S59D-N67D-A68S-N71D-K93R-N97D-Y129M-K143Q-P168S-Q184D-G225C-Y235L-K244L-S258D-N261R-T284E-Z298.01Q; wherein the amino acid positions of the variant or recombinant polypeptide or active fragment thereof are numbered by correspondence with the amino acid sequence of SEQ ID NO:1.

In one embodiment, the low temperature amylase is selected from: (a) a variant described in U.S. Pat. No. 5,856,164, WO9923211, WO9623873, WO0060060, WO06002643, WO2008112459, WO2009061380, WO2009100102, WO2010115028, WO2014183920, WO2014164777, WO2015149641, WO2015077126, and U.S. Provisional Patent Appl No. 62/265,301, filed Dec. 9, 2015; (b) a variant comprising one or more substitution in one or more positions versus SEQ ID NO:2 selected from 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, and 484, and wherein said variant, optionally, further comprises one or more deletions at one or more position versus SEQ ID NO:2 selected from 118, 183, 184, 195, 320, and 458; (c) one or more substitutions in SEQ ID NO:2 selected from 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, and, optionally, one or more deletion at one or more position in SEQ ID NO:2 selected from 183 and 184; (d) a variant comprising at least 90% amino acid sequence identity to the amino acid sequence of SEQ ID NO:3, wherein said variant optionally further comprises deletions in SEQ ID NO:3 at positions 183 and 184; (e) a variant comprising an A and B domain, and a C domain, wherein the A and B domain is at least 75%, 80%, 85%, 90%, 91%, 92%, 93%, 94%, 95%, 96%, 97%, 98%, 99%, or 100% identical to the polypeptide with the amino acid sequence of residues 1-399 of SEQ ID NO:4, which is used for numbering, and the C domain is at least 75% 80%, 85%, 90%, 91%, 92%, 93%, 94%, 95%, 96%, 97%, 98%, 99%, or 100% identical to the polypeptide with the amino acid sequence of residues 398-483 of SEQ ID NO:5, which is used for numbering, wherein the A and B domain, optionally, comprises a deletion of two or more amino acids corresponding to positions 181, 182, 183, and 184 of the amino acid sequence of SEQ ID NO:4, and wherein the C domain, optionally, comprises one or more substitutions selected from I403L, A419H, A420P, and A426T; (f) a variant comprising at least 95%, 96%, 97%, 98%, or 99% amino acid sequence identity to the amino acid sequence of SEQ ID NO:4, wherein said variant, optionally, comprises one or more substitutions at one or more positions selected from M202, M208, S255, R172, and M261; (g) a variant comprising a substitution at an amino acid residue corresponding to R375 and, optionally, S360 of SEQ ID NO:8, and one or two or more substitutions at one or more amino acid residues corresponding to amino acid residues in SEQ ID NO:8 selected from N126, F153, T180, E187, and 1203, wherein said variant has at least 60%, 70%, 80%, 85%, 90% or 95% amino acid sequence identity to SEQ ID NO:8, and wherein SEQ ID NO:8 is used for numbering; (h) a variant comprising one or two or more substitutions at one or more amino acid residue corresponding to amino acid residues in SEQ ID NO:8 selected from T38, N126, F153, T180, E187, 1203, G476, and G477, and, optionally, one or more deletion at one or more amino acid residues corresponding to amino acid residues in SEQ ID NO:8 selected from R178, G179, T180, and G181, wherein said variant has at least 60%, 70%, 80%, 85%, 90% or 95% amino acid sequence identity to SEQ ID NO:8, and wherein SEQ ID NO:8 is used for numbering; (i) a variant comprising two substitutions at amino acid residue corresponding to E187 and 1203 of SEQ ID NO:8, and, optionally, one or more substitutions at one or more amino acid residues corresponding to amino acid residues in SEQ ID NO:8 selected from R458, T459, D460, and G476, and, optionally, one or more deletion at one or more amino acid residues corresponding to amino acid residues in SEQ ID NO:8 selected from R178, G179, T180, and G181, wherein said variant has at least 60%, 70%, 80%, 85%, 90% or 95% amino acid sequence identity to SEQ ID NO:8, and wherein SEQ ID NO:8 is used for numbering; (j) a variant comprising a combination of substitutions in SEQ ID NO:9 selected from N125Y/E186P/T333G/A335S/Q337E/G472K, N125Y/F152W/E186P/T333G/A335S/Q337E/G472K, N125Y/F152W/E186P/T333G/A335S/Q337E/G472R/G473R, N125Y/F152W/E186P/N205D/T333G/A335S/Q337E/G472K, N125Y/E186P/T333G/A335S/G472K, N125Y/F152W/E186P/T333G/A335S/G472K, N125Y/F152W/E186P/T333G/A335S/G472R/G473R, N125Y/F152W/E186P/N205D/T333G/A335S/G472K, N125Y/E186P/T333G/G472K, N125Y/F152W/E186P/T333G/G472K, N125Y/F152W/E186P/T333G/G472R/G473R, and N125Y/F152W/E186P/N205D/T333G/G472K, and, optionally, one or more deletions of one or more amino acid residues corresponding to amino acid residues in SEQ ID NO:9 selected from R178, G179, T180, and G181, wherein said variant has at least 60%, 70%, 80%, 85%, 90% or 95% amino acid sequence identity to SEQ ID NO:9; and (k) a variant comprising a substitution at one or more positions selected from 83, 125, 128, 131, 160, 178, 182, 183, 185, 189, 279, 305, 319, 320, 379, 407, 433, 453, 475, 476, and 483, and, optionally, a substitution at position 243 and/or a deletion at position 180 and/or position 181, wherein the positions correspond to amino acid residues in the amino acid sequence set forth in SEQ ID NO:10, and wherein the variant has at least 90% amino acid sequence identity to SEQ ID NO:10.

In another embodiment, the low temperature amylase is selected from: (a) a variant comprising one, two or three or more substitutions in SEQ ID NO:2 selected from 9, 26, 149, 182, 186, 202, 257, 295, 299, 323, 339, and 345, and, optionally, one or more deletions at one or more positions in SEQ ID NO:2 selected from 183 and 184; (b) variant comprising one, two or three or more substitutions versus SEQ ID NO:2 selected from 9, 26, 149, 182, 186, 202, 257, 295, 299, 323, 339, and 345, and, optionally, one or more deletions at one or more positions versus SEQ ID NO:2 selected from 183 and 184; (c) a variant comprising substitutions R118K, N195F, R320K, and R458K in SEQ ID NO:2 and deletions in SEQ ID NO 2 of positions D183 and G184; (d) a variant comprising at least 90% amino acid sequence identity to the amino acid sequence of SEQ ID NO:3, wherein said variant further comprises deletions in SEQ ID NO:3 of position 183 and 184; (e) a variant comprising at least 80%, 85%, 90%, 95%, or 100% identity to SEQ ID NO:6; (f) a variant comprising at least 95%, 96%, 97%, 98%, or 99% identity with SEQ ID NO:4 and one or more substitutions in SEQ ID NO:4 selected from M202L, M202V, M202S, M202T, M202I, M202Q, M202W, S255N, and R172Q, wherein SEQ ID NO:4 is used for numbering; (g) a variant comprising at least 95%, 96%, 97%, 98%, or 99% identity with SEQ ID NO:4 and substitution M202L in SEQ ID NO:4, wherein SEQ ID NO:4 is used for numbering; (h) a variant comprising a substitution at an amino acid residue corresponding to R375Y and, optionally, S360A of SEQ ID NO:8, and one or two or more substitutions at one or more amino acid residues corresponding to amino acid residues in SEQ ID NO:8 selected from N126Y, F153W, T180H, E187P, and I203Y, and, optionally, one or more deletion of one or more amino acid residues corresponding to amino acid residues in SEQ ID NO:8 selected from R178, G179, T180, and G181, and wherein SEQ ID NO:8 is used for numbering; (i) a variant comprising one or two or more substitutions at one or more amino acid residues corresponding to amino acid residues in SEQ ID NO:8 selected from T38N, N126Y, F153W, E187P, I203Y, G476K, and G477E, and, optionally, a deletion of amino acid residues corresponding to R178 and G179 of SEQ ID NO:8, or T180 and G181 of SEQ ID NO:8, wherein SEQ ID NO:8 is used for numbering; (j) a variant comprising two substitutions at amino acid residues corresponding to E187P and I203Y of SEQ ID NO:8, and, optionally, one or more substitutions at one or more amino acid residues corresponding to amino acid residues in SEQ ID NO:8 selected from R458N, T459S, D460T, and G476K, and, optionally, a deletion of amino acid residues corresponding to R178 and G179 of SEQ ID NO:8, or T180 and G181 of SEQ ID NO:8, wherein said variant has at least 60%, 70%, 80%, 85%, 90% or 95% amino acid sequence identity to SEQ ID NO:8, and wherein SEQ ID NO:8 is used for numbering; and (k) a variant comprising the combination of substitutions S243Q/G475K and a deletion at position R180 and S181, wherein the positions correspond to amino acid residues in the amino acid sequence set forth in SEQ ID NO:10, and wherein the variant has at least 90% amino acid sequence identity to SEQ ID NO:10.

In another embodiment, the low temperature protease is a subtilisin protease variant selected from a variant described in WO2009149145, WO2011072099, WO2011140364, WO2012151534, WO2016145428, PCT/US16/32514, U.S. Provisional Patent Appl. No. 62/332,417, filed May 5, 2016, and U.S. Provisional Patent Appl. No. 62/343,618, filed May 31, 2016. In a further embodiment, the low temperature protease is a subtilisin protease variant comprising an amino acid sequence comprising two, three, or four or more variations versus SEQ ID NO:19 at positions selected from: (i) 1, 3, 9, 10, 15, 17, 19, 22, 24, 25, 26, 27, 28, 30, 35, 37, 38, 43, 45, 48, 68, 71, 74, 76, 77, 78, 86, 87, 91, 95, 96, 98, 99, 100, 102, 103, 108, 111, 114, 115, 120, 123, 125, 126, 127, 128, 129, 130, 136, 143, 146, 147, 151, 155, 160, 165, 183, 184, 187, 193, 202, 203, 210, 217, 234, 238, 239, 240, 242, 247, 250, 251, 255, 258, 259, 260, and 274; (ii) 1, 3, 9, 15, 22, 24, 28, 30, 35, 37, 45, 48, 68, 71, 74, 76, 77, 78, 86, 87, 95, 96, 98, 99, 100, 108, 114, 115, 120, 123, 125, 126, 127, 128, 129, 130, 143, 146, 147, 151, 155, 165, 183, 184, 187, 193, 202, 203, 210, 217, 234, 238, 239, 240, 242, 247, 250, 255, 258, 259, 260, and 274; (iii) 1, 3, 15, 35, 68, 71, 77, 86, 87, 95, 99, 115, 123, 127, 128, 147, 155, 165, 184, 202, 210, 217, 234, 239, 242, 250, 258, and 274; or (iv)3, 68, 77, 86, 99, 115, 123, 127, 128, 165, 184, 202, 210, 217, and 258; with the proviso that one or more of said two, three, or four or more variations is a non-naturally occurring amino acid; wherein said variant has 85% or more amino acid sequence identity to the amino acid sequence of SEQ ID NO:19; and, optionally, wherein said subtilisin protease variant is from a parent comprising the amino acid sequence of SEQ ID NO:19; and wherein the amino acid positions of the variant are numbered by correspondence with the amino acid sequence of SEQ ID NO:19.

In a still further embodiment, the low temperature protease is a subtilisin protease variant comprising an amino acid sequence comprising two, three, or four or more variations versus SEQ ID NO:19 at positions selected from: (i) 1Q, 3Q/V, 9E/T, 10M, 15I/V, 17H, 19E, 22Y, 24N, 25D, 26R, 27R, 28A, 30T, 35A, 37T, 38G, 43A, 45I/R, 48I, 68S, 71A, 74G, 76K, 77D/H/N/Q/S, 78I, 86H/N/R, 87S/T, 91G, 95A/Q, 96S, 98H/K/R, 99L/S, 100N/R, 102R, 103I, 108H/K, 111Q, 114N, 115F, 120A, 123I, 125N, 126Q, 127F/T, 128P/S, 129T, 130S, 136A/R, 143V, 146A/S, 147L, 151G, 155A/E/G, 160C/R, 165A/E/Q/S, 183A/G, 184Q, 187P, 193D, 202V, 203E/N, 210E/H/P, 217S, 234I/W, 238R/T, 239K/S/T, 240N, 242G, 247W, 250G, 251E, 255R, 258E/H/P, 259P, 260W, and 274A/F; (ii) 1Q, 3Q/V, 9E, 1I, 22Y, 24N, 28A, 30T, 35A, 37T, 45I, 48I, 68S, 71A, 74G, 76K, 77D/H/N/S, 78I, 86H/N/R, 87S/T, 95A/Q, 96S, 98K, 99L/S, 100N, 108H/K, 114N, 115F, 120A, 123I, 125N, 126Q, 127F/T, 128P/S, 129T, 130S, 143V, 146A/S, 147L, 151G, 155A/E/G, 165A/E/Q/S, 183G, 184Q, 187P, 193D, 202V, 203E/N, 210P, 217S, 234I/W, 238R/T, 239K/S/T, 240N, 242G, 247W, 250G, 255R, 258P, 259P, 260W, and 274A; (iii) 1Q, 3V, 15I, 35A, 68S, 71A, 77N, 86H, 87S, 95A, 99S, 115F, 123I, 127T, 128P/S, 147L, 155G, 165Q/S, 184Q, 202V, 210P, 217S, 234W, 239S, 242G, 250G, 258P, and 274A; or (iv) 3V, 68S, 77N, 86H, 99S, 115F, 123I, 127T, 128P, 165Q, 184Q, 202V, 210P, 217S, and 258P; with the proviso that one or more of said two, three, or four or more variations is a non-naturally occurring amino acid; wherein said variant has 85% or more amino acid sequence identity to the amino acid sequence of SEQ ID NO:19; and, optionally, wherein said subtilisin protease variant is from a parent comprising the amino acid sequence of SEQ ID NO:19; and wherein the amino acid positions of the variant are numbered by correspondence with the amino acid sequence of SEQ ID NO:19.

In an even still further embodiment, the low temperature protease is a subtilisin protease variant comprising an amino acid sequence comprising two, three, or four or more amino acid substitutions selected from: (i) A/G1Q, T3Q/V, P9E/T, L/Q10M, K15I/V, Q17H, Q19E, K22Y, A24N, N25D, V26R, K27R, G/V28A, I/V30T, I35A, A/S37T, S38G, N/K43A, V45I/R, A48I, A68S, V71A, L74G, N76K, S/T77D/H/N/Q/S, T78I, N/S86H/N/R/S, V87S/T, A/I91G, L95A/Q, N96S, S98H/K/R, G99L/S, S100N/R, S/T102R, Y103I, S108H/K, E111Q, T114N, A/Q/T115F, V120A, M123I, L125N, G126Q, G127F/T, A/P/T128P/S, S129T, G/V130S, Q136A/R, A/S143V, A/I/V146A/S, V147L, A/S151G, S155A/E/G, N/S/Y160C/R, G165A/E/Q/S, G/K/N/S183A/G, N184Q, S187P, A/P/S193D, K194E, A/S202V, G/S203E/N, S/T210E/H/P, S211N, N217S, L234I/W, P238R/T, A/N/T239K/S/T, A242G, D/N/T247W, S250G, R/S251E, N/Y255R, D/S258E/H/P, S259P, F260W, and Q274A/F; (ii) A/G1Q, T3Q/V, P9E, K15I, K22Y, A24N, G/V28A, I/V30T, I35A, A/S37T, V45I, A48I, A68S, V71A, L74G, N76K, S/T77D/H/N/S, T78I, N/S86H/N/R/S, V87S/T, L95A/Q, N96S, S98K, G99L/S, S100N, S108H/K, T114N, A/Q/T115F, V120A, M123I, L125N, G126Q, G127F/T, A/P/T128P/S, S129T, G/V130S, A/S143V, A/I/V146A/S, V147L, A/S151G, S155A/E/G, G165A/E/Q/S, K/S183G, N184Q, S187P, A/P/S193D, K194E, A/S202V, G/S203E/N, S/T210P, S211N, N217S, L234I/W, P238R/T, A/N/T239K/S/T, A242G, D/N/T247W, S250G, N/Y255R, D/S258P, S259P, F260W, and Q274A; (iii) A/G1Q, T3V, K15I, 135A, A68S, V71A, S/T77N, N/S86H, V87S, L95A, G99S, A/Q/T115F, M123I, G127T, A/P/T128P/S, V147L, S155G, G165Q/S, N184Q, A/S202V, S/T210P, N217S, L234W, A/N/T239S, A242G, S250G, D/S258P, and Q274A; or (iv) T3V, A68S, S/T77N, N/S86H, G99S, A/Q/T115F, M123I, G127T, A/T128P, G165Q, N184Q, A/S202V, S/T210P, N217S, and D/S258P; with the proviso that one or more of said two, three, or four or more variations is a non-naturally occurring amino acid; wherein said variant has 85% or more amino acid sequence identity to the amino acid sequence of SEQ ID NO:19; and, optionally, wherein said subtilisin protease variant is from a parent comprising the amino acid sequence of SEQ ID NO:19; and wherein the amino acid positions of the variant are numbered by correspondence with the amino acid sequence of SEQ ID NO:19.

In yet another embodiment, the low temperature protease is a subtilisin protease variant comprising (i) 80%, 85%, 90%, 95%, 96%, 97%, 98%, 99% amino acid sequence identity to the amino acid sequence of SEQ ID NO:18 and two, three, or four or more substitutions selected from positions 22, 68, 76, 101, 103, 104, 106, 116, 120, 159, 188, 167, 170, 194, 195, 232, 235, 245, 248, and 271; (ii) 80%, 85%, 90%, 95%, 96%, 97%, 98%, 99% amino acid sequence identity to the amino acid sequence of SEQ ID NO:18 and two, three, or four or more substitutions selected from T22A/R, N76D, V68A, S101G, S103A, V1041, S106A, N116L, H120D, G159D, Y167A, R170S, S188D, A194P, G195E, A232V, K235N, Q245R, N248D, and E271F; (iii) 80%, 85%, 90%, 95%, 96%, 97%, 98%, 99% amino acid sequence identity to the amino acid sequence of SEQ ID NO:17 and two, three, or four or more substitutions selected from positions 24, 33, 53, 76, 78, 97, 101, 109, 128, 217, 243, and 248; or (iv) 80%, 85%, 90%, 95%, 96%, 97%, 98%, 99% amino acid sequence identity to the amino acid sequence of SEQ ID NO:17 and two, three, or four or more substitutions selected from S24G, S33T, S53G, N76D, S78N, G97A, S101N, N109G, G128A/S, Y217L/Q, N243V, and S248A; and wherein the amino acid positions of the said subtilisin protease variant are numbered by correspondence with the amino acid sequence of SEQ ID NO:17.

In one embodiment, the laundry detergent composition described herein is in a form selected from powder, liquid, granular, bar, solid, semi-solid, gel, paste, emulsion, tablet, capsule, unit dose, sheet, and foam. In some embodiments, the laundry detergent composition described herein is in a form selected from a low water compact formula, low water HDL or UD, or high water formula or HDL. In other embodiments, the laundry detergent composition describe herein is in a unit dose form. In yet still other embodiments, the unit does form is selected from pills, tablets, capsules, gelcaps, sachets, pouches, multi-compartment pouches, and pre-measured powders or liquids. In further embodiments, the unit dose format is designed to provide controlled release of the ingredients within a multi-compartment pouch (or other unit dose format). Suitable unit dose and controlled release formats are described, for example, in EP2100949, WO02102955, U.S. Pat. Nos. 4,765,916, 4,972,017, and WO04111178. In still further embodiments, the unit dose form is a tablet or powder contained in a water-soluble film or pouch.

Enzyme component weights are based on total active protein. All percentages and ratios are calculated by weight unless otherwise indicated. All percentages and ratios are calculated based on the total composition unless otherwise indicated. In laundry detergent compositions, the enzyme levels are expressed in ppm, which equals mg active protein/kg detergent composition.

In some embodiments, the laundry detergent compositions described herein further comprise a surfactant. In some embodiments, the surfactant is selected from a non-ionic, ampholytic, semi-polar, anionic, cationic, zwitterionic, and combinations and mixtures thereof. In yet a further embodiment, the surfactant is selected from an anionic surfactant, a cationic surfactant, a zwitterionic surfactant, and combinations thereof. In some embodiments, the laundry detergent compositions described herein comprise from about 0.1% to about 60%, about 1% to about 50%, or about 5% to about 40% surfactant by weight of the composition. Exemplary surfactants include, but are not limited to sodium dodecylbenzene sulfonate, C12-14 pareth-7, C12-15 pareth-7, sodium C12-15 pareth sulfate, C14-15 pareth-4, sodium laureth sulfate (e.g., Steol CS-370), sodium hydrogenated cocoate, C12 ethoxylates (Alfonic 1012-6, Hetoxol LA7, Hetoxol LA4), sodium alkyl benzene sulfonates (e.g., Nacconol 90G), and combinations and mixtures thereof. Anionic surfactants include but are not limited to linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap. Nonionic surfactants include but are not limited to alcohol ethoxylate (AEO or AE), carboxylated alcohol ethoxylates, nonylphenol ethoxylate, alkylpolyglycoside, alkyldimethylamine oxide, ethoxylated fatty acid monoethanolamide, fatty acid monoethanolamide, polyhydroxy alkyl fatty acid amide (e.g., as described in WO92/06154), polyoxyethylene esters of fatty acids, polyoxyethylene sorbitan esters (e.g., TWEENs), polyoxyethylene alcohols, polyoxyethylene isoalcohols, polyoxyethylene ethers (e.g., TRITONs and BRIJ), polyoxyethylene esters, polyoxyethylene-p-tert-octylphenols or octylphenyl-ethylene oxide condensates (e.g., NONIDET P40), ethylene oxide condensates with fatty alcohols (e.g., LUBROL), polyoxyethylene nonylphenols, polyalkylene glycols (SYNPERONIC F108), sugar-based surfactants (e.g., glycopyranosides, thioglycopyranosides), and combinations and mixtures thereof.

In a further embodiment, the laundry detergent compositions described herein further comprise a surfactant mixture that includes, but is not limited to 5-15% anionic surfactants, <5% nonionic surfactants, cationic surfactants, phosphonates, soap, enzymes, perfume, butylphenyl methylpropionate, geraniol, zeolite, polycarboxylates, hexyl cinnamal, limonene, cationic surfactants, citronellol, and benzisothiazolinone.

The laundry detergent compositions described herein may additionally include one or more detergent builders or builder systems, a complexing agent, a polymer, a bleaching system, a stabilizer, a foam booster, a suds suppressor, an anti-corrosion agent, a soil-suspending agent, an anti-soil redeposition agent, a dye, a bactericide, a hydrotope, an optical brightener, a fabric conditioner, and a perfume. The laundry detergent compositions described herein may also include additional enzymes selected from proteases, amylases, cellulases, lipases, mannanases, pectinases, xyloglucanases, or perhydrolases.

In some embodiments, the laundry detergent compositions described herein further comprises from about 1%, from about 3% to about 60% or even from about 5% to about 40% builder by weight of the cleaning composition. Builders may include, but are not limited to, the alkali metals, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metals, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

In some embodiments, the builders form water-soluble hardness ion complexes (e.g., sequestering builders), such as citrates and polyphosphates (e.g., sodium tripolyphosphate and sodium tripolyphospate hexahydrate, potassium tripolyphosphate, and mixed sodium and potassium tripolyphosphate, etc.). Any suitable builder can find use in the compositions described herein, including those known in the art.

In some embodiments, the laundry detergent compositions described herein further comprise an adjunct ingredient including, but not limited to surfactants, builders, bleaches, bleach activators, bleach catalysts, additional enzymes, an enzyme stabilizer (including, for example, an enzyme stabilizing system), chelants, optical brighteners, soil release polymers, dye transfer agents, dye transfer inhibiting agents, catalytic materials, hydrogen peroxide, sources of hydrogen peroxide, preformed peracids, polymeric dispersing agents, clay soil removal agents, structure elasticizing agents, dispersants, suds suppressors, dyes, perfumes, colorants, filler salts, hydrotropes, photoactivators, fluorescers, fabric conditioners, hydrolyzable surfactants, solvents, preservatives, anti-oxidants, anti-shrinkage agents, anti-wrinkle agents, germicides, fungicides, color speckles, anti-corrosion agents, alkalinity sources, solubilizing agents, carriers, processing aids, pigments, pH control agents, and combniations thereof. (See, e.g., U.S. Pat. Nos. 6,610,642, 6,605,458, 5,705,464, 5,710,115, 5,698,504, 5,695,679, 5,686,014, and 5,646,101). In some embodiments, one or more adjunct is incorporated for example, to assist or enhance cleaning performance, for treatment of the substrate to be cleaned, or to modify the aesthetics of the cleaning composition as is the case with perfumes, colorants, dyes or the like. Any such adjunct ingredient is in addition to the low temperature mannanase, low temperature amylase, and/or low temperature protease described herein. In some embodiments, the adjunct ingredient is selected from surfactants, enzyme stabilizers, builder compounds, polymeric compounds, bleaching agents, additional enzymes, suds suppressors, dispersants, lime-soap dispersants, soil suspension agents, softening agents, anti-redeposition agents, corrosion inhibitors, and combinations thereof.

In some further embodiments, the laundry detergent compositions described herein comprise one or more enzyme stabilizer. In some embodiments, the enzyme stabilizer is a water-soluble source of calcium and/or magnesium ions. In some embodiments, the enzyme stabilizers include oligosaccharides, polysaccharides, and inorganic divalent metal salts, including alkaline earth metals, such as calcium salts. In some embodiments, the enzymes employed herein are stabilized by the presence of water-soluble sources of zinc (II), calcium (II) and/or magnesium (II) ions in the finished compositions that provide such ions to the enzymes, as well as other metal ions (e.g., barium (II), scandium (II), iron (II), manganese (II), aluminum (III), tin (II), cobalt (II), copper (II), nickel (II), and oxovanadium (IV)). Chlorides and sulfates also find use in some embodiments. Exemplary oligosaccharides and polysaccharides (e.g., dextrins) are described, for example, in WO07145964. In some embodiments, the laundry detergent compositions described herein contain reversible protease inhibitors selected from a boron-containing compound (e.g., borate, 4-formyl phenyl boronic acid, and phenyl-boronic acid derivatives, such as, e.g., are described in WO9641859); a peptide aldehyde (such as, e.g., is described in WO2009118375 and WO2013004636), and combinations thereof.

The cleaning compositions herein are typically formulated such that, during use in aqueous cleaning operations, the wash water will have a pH of from about 3.0 to about 11. Liquid product formulations are typically formulated to have a neat pH from about 5.0 to about 9.0. Granular laundry products are typically formulated to have a pH from about 8.0 to about 11.0. Techniques for controlling pH at recommended usage levels include the use of buffers, alkalis, acids, etc., and are well known to those skilled in the art.

Suitable high pH cleaning compositions typically have a neat pH of from about 9.0 to about 11.0, or even a neat pH of from 9.5 to 10.5. Such cleaning compositions typically comprise a sufficient amount of a pH modifier, such as sodium hydroxide, monoethanolamine, or hydrochloric acid, to provide such cleaning composition with a neat pH of from about 9.0 to about 11.0. Such compositions typically comprise at least one base-stable enzyme. In some embodiments, the compositions are liquids, while in other embodiments, they are solids.

Concentrations of detergent compositions in typical wash solutions throughout the world vary from less than about 800 ppm of detergent composition (“low detergent concentration geographies”), for example about 667 ppm in Japan, to between about 800 ppm to about 2000 ppm (“medium detergent concentration geographies”), for example about 975 ppm in U.S. and about 1500 ppm in Brazil, to greater than about 2000 ppm (“high detergent concentration geographies”), for example about 4500 ppm to about 5000 ppm in Europe and about 6000 ppm in high suds phosphate builder geographies.

In some embodiments, the detergent compositions described herein may be utilized at a temperature of from about 10° C. to about 60° C., or from about 20° C. to about 60° C., or from about 30° C. to about 60° C., from about 40° C. to about 60° C., from about 40° C. to about 55° C., or all ranges within 10° C. to 60° C. In some embodiments, the detergent compositions described herein are used in “cold water washing” at temperatures of from about 10° C. to about 40° C., or from about 20° C. to about 30° C., from about 15° C. to about 25° C., from about 15° C. to about 35° C., or all ranges within 10° C. to 40° C.

As a further example, different geographies typically have different water hardness. Water hardness is usually described in terms of the grains per gallon mixed Ca²⁺/Mg²⁺. Hardness is a measure of the amount of calcium (Ca²⁺) and magnesium (Mg²⁺) in the water. Most water in the United States is hard, but the degree of hardness varies. Moderately hard (60-120 ppm) to hard (121-181 ppm) water has 60 to 181 parts per million (parts per million converted to grains per U.S. gallon is ppm #divided by 17.1 equals grains per gallon) of hardness minerals.

TABLE II
Water Hardness Levels

| Water | Grains per gallon | Parts per million |
|---|---|---|
| Soft | less than 1.0 | less than 17 |
| Slightly hard | 1.0 to 3.5 | 17 to 60 |
| Moderately hard | 3.5 to 7.0 | 60 to 120 |
| Hard | 7.0 to 10.5 | 120 to 180 |
| Very hard | greater than 10.5 | greater than 180 |

European water hardness is typically greater than about 10.5 (for example about 10.5 to about 20.0) grains per gallon mixed Ca²⁺/Mg²⁺ (e.g., about 15 grains per gallon mixed Ca²⁺/Mg²⁺). North American water hardness is typically greater than Japanese water hardness, but less than European water hardness. For example, North American water hardness can be between about 3 to about 10 grains, about 3 to about 8 grains or about 6 grains. Japanese water hardness is typically lower than North American water hardness, usually less than about 4, for example about 3 grains per gallon mixed Ca²⁺/Mg²⁺.

In some embodiments, the laundry detergent compositions described herein exhibit enhanced cleaning performance in cold water washing and/or in shortened wash cycles.

In one embodiment, the laundry detergent compositions described herein further comprises one or more additional enzyme selected from: acyl transferases, amylases, alpha-amylases, beta-amylases, alpha-galactosidases, arabinases, arabinosidases, aryl esterases, beta-galactosidases, beta-glucanases, carrageenases, catalases, cellobiohydrolases, cellulases, chondroitinases, cutinases, endo-beta-1, 4-glucanases, endo-beta-mannanases, exo-beta-mannanases, esterases, exo-mannanases, galactanases, glucoamylases, hemicellulases, hyaluronidases, keratinases, laccases, lactases, ligninases, lipases, lipolytic enzymes, lipoxygenases, mannanases, oxidases, pectate lyases, pectin acetyl esterases, pectin degrading enzyme, pentosanases, peroxidases, phenoloxidases, phosphatases, phospholipases, phytases, polygalacturonases, proteases, pullulanases, reductases, rhamnogalacturonases, beta-glucanases, tannases, transglutaminases, xylan acetyl-esterases, xylanases, xyloglucanases, xylosidases, and metalloproteases.

In one embodiment, the laundry detergent compositions described herein further comprise one or more additional mannanase either alone or in combination with the low temperature mannanases described herein. Suitable additional mannanases include, but are not limited to, mannanases of the GH26 family of glycosyl hydrolases, mannanases of the GH5 family of glycosyl hydrolases, acidic mannanases, neutral mannanases, and alkaline mannanases. Examples of alkaline mannanases include those described in U.S. Pat. Nos. 6,060,299, 6,566,114, 6,602,842, WO9535362, WO9964573, WO9964619, and WO2015022428. Suitable additional mannanases include, but are not limited to those of animal, plant, fungal, or bacterial origin. Exemplary, additional mannanases include commercially available endo-β-mannanases such as HEMICELL® (Chemgen); GAMANASE® and MANNAWAY®, (Novozymes A/S, Denmark); EFFECTENZ™ M 1000, PREFERENZ® M 100, PURABRITE™ and MANNASTAR™ (DuPont); and PYROLASE® 160 and PYROLASE® 200 (Diversa).

In some embodiments, the laundry detergent compositions described herein further comprise one or more additional protease either alone or in combination with the low temperature protease described herein. In some embodiments, the laundry detergent composition described herein comprises from about 0.00001% to about 10%, about 0.001% to about 5%, about 0.001% to about 2%, or about 0.005% to about 0.5% additional protease by weight of the composition. In one embodiment, the additional protease is a serine protease. Suitable additional proteases include those of animal, vegetable or microbial origin. In some embodiments, the additional protease is a microbial protease. In other embodiments, the additional protease is a chemically or genetically modified mutant. In another embodiment, the additional protease is an alkaline microbial protease or a trypsin-like protease. Exemplary alkaline proteases include subtilisins derived from, for example, Bacillus (e.g., subtilisin, lentus, amyloliquefaciens, subtilisin Carlsberg, subtilisin 309, subtilisin 147 and subtilisin 168). Exemplary additional proteases include but are not limited to those described in WO9221760, WO9523221, WO 2008010925, WO09149200, WO09149144, WO09149145, WO10056640, WO10056653, WO20100566356, WO11072099, WO201113022, WO11140364, WO12151534, WO2015038792, WO2015089447, WO2015089441, WO2015143360, WO2016061438, WO 2016069548, WO 2016069544, WO2016069557, WO2016069563, WO2016069569, WO2016 069552, WO2016145428, US20080090747, U.S. Pat. Nos. 5,801,039, 5,340,735, 5,500,364, 5,855,625, RE34606, U.S. Pat. Nos. 5,955,340, 5,700,676, 6,312,936, 6,482,628, 8,530,219, U.S. Provisional Appl Nos. 62/331,282, 62/332,417, 62/343,618, and 62/351,649, and PCT Appl Nos. PCT/US16/32514 and PCT/US2016/038245, as well as metalloproteases described in WO1999014341, WO1999033960, WO1999014342, WO1999034003, WO2007044993, WO 2009058303, WO2009058661, WO2014071410, WO2014194032, WO2014194034, WO2014 194054, and WO2014194117. Exemplary additional proteases include, but are not limited to trypsin (e.g., of porcine or bovine origin) and the Fusarium protease described in WO8906270. Exemplary additional proteases include commercial proteases including, but not limited to MAXATASE®, MAXACAL™, MAXAPEM™, OPTICLEAN®, OPTIMASE®, PROPERASE®, PURAFECT®, PURAFECT® OXP, PURAMAX™, EXCELLASE™, PREFERENZ™ proteases (e.g. P100, P110, P280), EFFECTENZ™ proteases (e.g. P1000, P1050, P2000), EXCELLENZ™ proteases (e.g. P1000), ULTIMASE®, and PURAFAST™ (DuPont); ALCALASE®, BLAZE®, BLAZE® EVITY®, BLAZE® EVITY® 16L, CORONASE®, SAVINASE®, SAVINASE® ULTRA, SAVINASE® EVITY®, SAVINASE® EVERIS®, PRIMASE®, DURAZYM™, POLARZYME®, OVOZYME®, KANNASE®, LIQUANASE®, LIQUANASE EVERIS®, NEUTRASE®, PROGRESS UNO®, RELASE® and ESPERASE® (Novozymes); BLAP™ and BLAP™ variants (Henkel); LAVERGY™ PRO 104 L (BASF), and KAP (B. alkalophilus subtilisin (Kao)).

In some embodiments, the laundry detergent compositions described herein comprise one or more additional amylase either alone or in combination with the low temperature amylase described herein. In one embodiment, the laundry detergent compositions described herein comprises from about 0.00001% to about 10%, about 0.0001% to about 10%, about 0.001% to about 5%, about 0.001% to about 2%, or about 0.005% to about 0.5% additional amylase by weight of the composition. Any amylase (e.g., alpha and/or beta) suitable for use in alkaline solutions may be useful to include in such composition. An exemplary additional amylase can be a chemically or genetically modified mutant. Exemplary additional amylases include, but are not limited to those of bacterial or fungal origin, such as, for example, amylases described in GB 1296839, WO9100353, WO9402597, WO94183314, WO9510603, WO9526397, WO9535382, WO9605295, WO9623873, WO9623874, WO 9630481, WO9710342, WO9741213, WO97 43424, WO9813481, WO 9826078, WO9902702, WO 9909183, WO9919467, WO9923211, WO9929876, WO9942567, WO 9943793, WO9943794, WO 9946399, WO0029560, WO00 60058, WO0060059, WO0060060, WO0114532, WO0134784, WO0164852, WO0166712, WO 0188107, WO0196537, WO02092797, WO0210355, WO0231124, WO2004055178, WO2004 113551, WO2005001064, WO2005003311, WO2005018336, WO2005019443, WO2005 066338, WO2006002643, WO2006012899, WO2006012902, WO2006031554, WO2006 063594, WO2006066594, WO2006066596, WO2006136161, WO 2008000825, WO2008 088493, WO2008092919, WO2008101894, WO2008/112459, WO2009061380, WO2009 061381, WO2009100102, WO2009140504, WO2009149419, WO2010059413, WO2010 088447, WO2010091221, WO2010104675, WO2010115021, WO10115028, WO2010117511, WO2011076123, WO2011076897, WO2011080352, WO2011080353, WO2011080354, WO 2011082425, WO2011082429, WO 2011087836, WO2011098531, WO2013063460, WO 2013184577, WO2014099523, WO2014164777, and WO2015077126. Exemplary additional amylases include commercial amylases including, but not limited to AMPLIFY®, AMPLIFY PRIME®, DURAMYL®, TERMAMYL®, FUNGAMYL®, STAINZYME®, STAINZYME PLUS®, STAINZYME PLUS®, STAINZYME ULTRA®EVITY®, and BAN™ (Novozymes); EFFECTENZ™ S 1000, POWERASE™, PREFERENZ™ S 100, PREFERENZ™ S 110, EXCELLENZ™ S 2000, RAPIDASE® and MAXAMYL® P (DuPont).

In some embodiments, the laundry detergent compositions described herein further comprise a pectin degrading enzyme. As used herein, “pectin degrading enzyme(s)” encompass arabinanase (EC 3.2.1.99), galactanases (EC 3.2.1.89), polygalacturonase (EC 3.2.1.15) exo-polygalacturonase (EC 3.2.1.67), exo-poly-alpha-galacturonosidase (EC 3.2.1.82), pectin lyase (EC 4.2.2.10), pectin esterase (EC 3.1.1.11), pectate lyase (EC 4.2.2.2), exo-polygalacturonate lyase (EC 4.2.2.9) and hemicellulases such as endo-1,3-β-xylosidase (EC 3.2.1.32), xylan-1,4-O-xylosidase (EC 3.2.1.37) and α-L-arabinofuranosidase (EC 3.2.1.55). Pectin degrading enzymes are natural mixtures of the above mentioned enzymatic activities. Pectin enzymes therefore include the pectin methylesterases which hydrolyse the pectin methyl ester linkages, polygalacturonases which cleave the glycosidic bonds between galacturonic acid molecules, and the pectin transeliminases or lyases which act on the pectic acids to bring about non-hydrolytic cleavage of α-1,4 glycosidic linkages to form unsaturated derivatives of galacturonic acid.

Suitable pectin degrading enzymes include those of plant, fungal, or microbial origin. In some embodiments, chemically or genetically modified mutants are included. In some embodiments, the pectin degrading enzymes are alkaline pectin degrading enzymes, i.e., enzymes having an enzymatic activity of at least 10%, at least 25%, or at least 40% of their maximum activity at a pH of from about 7.0 to about 12. In other embodiments, the pectin degrading enzymes are enzymes having their maximum activity at a pH of from about 7.0 to about 12. Alkaline pectin degrading enzymes are produced by alkalophilic microorganisms e.g., bacterial, fungal, and yeast microorganisms such as Bacillus species. In some embodiments, the microorganisms are B. firmus, B. circulans, and B. subtilis as described in JP56131376 and JP 56068393. Alkaline pectin decomposing enzymes may include but are not limited to galacturan-1,4-α-galacturonidase (EC 3.2.1.67), poly-galacturonase activities (EC 3.2.1.15, pectin esterase (EC 3.1.1.11), pectate lyase (EC 4.2.2.2) and their iso enzymes. Alkaline pectin decomposing enzymes can be produced by the Erwinia species. In some embodiments, the alkaline pectin decomposing enzymes are produced by E. chrysanthemi, E. carotovora, E. amylovora, E. herbicola, and E. dissolvens as described in JP59066588, JP63042988, and in World J. Microbiol. Biotechnol. (8, 2, 115-120) 1992. In certain other embodiments, the alkaline pectin enzymes are produced by Bacillus species as disclosed in JP73006557 and Agr. Biol. Chem. (1972), 36 (2) 285-93. In some embodiments, the laundry deteregent compositions described herein comprise about 0.00001% to about 10%, about 0.0001% to about 10%, about 0.001% to about 5%, about 0.001% to about 2%, or about 0.005% to about 0.5% of pectin degrading enzyme by weight of the composition.

In some embodiments, the laundry deteregent compositions described herein further comprise a suitable xyloglucanase. Suitable xyloglucanases include, but are not limited to those of plant, fungal, or bacterial origin. Chemically or genetically modified mutants are included in some embodiments. As used herein, “xyloglucanase(s)” encompass the family of enzymes described by Vincken and Voragen at Wageningen University [Vincken et al (1994) Plant Physiol., 104, 99-107] and are able to degrade xyloglucans as described in Hayashi et al (1989) Annu. Rev. Plant. Physiol. Plant Mol. Biol., 40, 139-168. In some embodiments, the cleaning compositions described herein comprise from about 0.00001% to about 10%, about 0.0001% to about 10%, about 0.001% to about 5%, about 0.001% to about 2%, or about 0.005% to about 0.5% xyloglucanase by weight of the composition. Other embodiments, include alkaline xyloglucanases, i.e., enzymes having an enzymatic activity of at least 10%, at least 25%, or at least 40% of its maximum activity at a pH ranging from 7 to 12. Yet other embodiments are directed to xyloglucanases having a maximum activity at a pH of from about 7.0 to about 12.

In some further embodiments, the laundry detergent compositions described herein further comprise one or more cellulase. In one embodiment, the laundry detergent composition comprises from about 0.00001% to about 10%, 0.0001% to about 10%, about 0.001% to about 5%, about 0.001% to about 2%, or about 0.005% to about 0.5% cellulase by weight of the composition. An exemplary cellulase is a chemically or genetically modified mutant. Exemplary cellulases include, but are not limited to those of bacterial or fungal origin, such as, for example, those described in WO2005054475, WO2005056787, U.S. Pat. Nos. 7,449,318, 7,833,773, 4,435,307, EP0495257; and U.S. Provisional Appl. No. 62/296,678. Exemplary commercial cellulases include, but are not limited to, CELLUCLEAN®, CELLUZYME®, CAREZYME®, ENDOLASE®, RENOZYME®, and CAREZYME® PREMIUM (Novozymes); REVITALENZ™ 100, REVITALENZ™ 200/220, and REVITALENZ® 2000 (DuPont); and KAC-500(B)™ (Kao Corporation). In some embodiments, cellulases are incorporated as portions or fragments of mature wild-type or variant cellulases, wherein a portion of the N-terminus is deleted (see, e.g., U.S. Pat. No. 5,874,276).

In still further embodiments, the laundry detergent compositions described herein comprise one or more lipase. In some embodiments, the laundry detergent composition comprises from about 0.00001% to about 10%, about 0.0001% to about 10%, about 0.001% to about 5%, about 0.001% to about 2%, or about 0.005% to about 0.5% lipase by weight composition. An exemplary lipase is a chemically or genetically modified mutant. Exemplary lipases include, but are not limited to, e.g., those of bacterial or fungal origin, such as, e.g., H. lanuginosa lipase (see, e.g., EP258068 and EP305216), T. lanuginosus lipase (see, e.g., WO 2014059360 and WO2015010009), Rhizomucor miehei lipase (see, e.g., EP238023), Candida lipase, such as C. antarctica lipase (e.g., C. antarctica lipase A or B) (see, e.g., EP214761), Pseudomonas lipases such as P. alcaligenes and P. pseudoalcaligenes lipase (see, e.g., EP 218272), P. cepacia lipase (see, e.g., EP331376), P. stutzeri lipase (see, e.g., GB1372034), P. fluorescens lipase, Bacillus lipase (e.g., B. subtilis lipase (Dartois et al., Biochem. Biophys. Acta 1131:253-260 (1993)), B. stearothermophilus lipase (see, e.g., JP64744992), and B. pumilus lipase (see, e.g., WO9116422)). Exemplary cloned lipases include, but are not limited to Penicillium camembertii lipase (See, Yamaguchi et al., Gene 103:61-67 (1991)), Geotricum candidum lipase (See, Schimada et al., J. Biochem., 106:383-388 (1989)), and various Rhizopus lipases, such as, R. delemar lipase (See, Hass et al., Gene 109:117-113 (1991)), R. niveus lipase (Kugimiya et al., Biosci. Biotech. Biochem. 56:716-719 (1992)) and R. oryzae lipase. Other lipolytic enzymes, such as cutinases, may also find use in one or more composition described herein, including, but not limited to, e.g., cutinase derived from Pseudomonas mendocina (see, WO8809367) and/or Fusarium solani pisi (see, WO9009446). Exemplary commercial lipases include, but are not limited to M1 LIPASE™, LUMA FAST™, and LIPOMAX™ (DuPont); LIPEX®, LIPOCLEAN®, LIPOLASE® and LIPOLASE® ULTRA (Novozymes); and LIPASE P™ (Amano Pharmaceutical Co. Ltd).

In some embodiments, the laundry detergent compositions described herein further comprise peroxidases in combination with hydrogen peroxide or a source thereof (e.g., a percarbonate, perborate or persulfate). In some alternative embodiments, oxidases are used in combination with oxygen. Both types of enzymes are used for “solution bleaching” (i.e., to prevent transfer of a textile dye from a dyed fabric to another fabric when the fabrics are washed together in a wash liquor), preferably together with an enhancing agent (See, e.g., WO9412621 and WO9501426). Suitable peroxidases/oxidases include, but are not limited to those of plant, bacterial or fungal origin. Chemically or genetically modified mutants are included in some embodiments. In some embodiments, the laundry detergent compositions described herein comprise from about 0.00001% to about 10%, about 0.0001% to about 10%, about 0.001% to about 5%, about 0.001% to about 2%, about 0.005% to about 0.5% of peroxidase and/or oxidase by weight of the composition.

In some embodiments, the laundry detergent compositions described herein comprise one or more perhydrolase (See, e.g., WO05056782).

In some embodiments, the laundry detergent compositions described herein comprise at least one chelating agent. Suitable chelating agents may include, but are not limited to copper, iron, and/or manganese chelating agents, and mixtures thereof. In some embodiments, the laundry detergent compositions described herein comprises from about 0.1% to about 15% or even from about 3.0% to about 10% chelating agent by weight of composition.

In some still further embodiments, the laundry detergent compositions described herein comprise at least one deposition aid. Suitable deposition aids include, but are not limited to, polyethylene glycol, polypropylene glycol, polycarboxylate, soil release polymers such as polyterephthalic acid, clays such as kaolinite, montmorillonite, attapulgite, illite, bentonite, halloysite, and mixtures thereof.

In some embodiments, the laundry detergent compositions described herein comprise at least one anti-redeposition agent.

In some embodiments, the laundry detergent compositions described herein comprise one or more dye transfer inhibiting agent. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones, and polyvinylimidazoles, or mixtures thereof. In some embodiments, the laundry detergent compositions described herein comprise from about 0.0001% to about 10%, from about 0.01% to about 5%, or even from about 0.1% to about 3% dye transfer inhibiting agent by weight of composition.

In some embodiments, the laundry detergent compositions described herein comprise one or more silicates. In some such embodiments, sodium silicates (e.g., sodium disilicate, sodium metasilicate, and crystalline phyllosilicates) find use. In some embodiments, the laundry detergent compositions described herein comprise from about 1% to about 20% or from about 5% to about 15% silicate by weight of the composition.

In yet further embodiments, the laundry detergent compositions described herein comprise one or more dispersant. Suitable water-soluble organic materials include, but are not limited to the homo- or co-polymeric acids or their salts, in which the polycarboxylic acid comprises at least two carboxyl radicals separated from each other by not more than two carbon atoms.

In some embodiments, the laundry detergent compositions described herein comprise one or more bleach, bleach activator, and/or bleach catalyst. In some embodiments, the laundry detergent compositions described herein comprise inorganic and/or organic bleaching compound(s). Inorganic bleaches may include, but are not limited to perhydrate salts (e.g., perborate, percarbonate, perphosphate, persulfate, and persilicate salts). In some embodiments, inorganic perhydrate salts are alkali metal salts. In some embodiments, inorganic perhydrate salts are included as the crystalline solid, without additional protection, although in some other embodiments, the salt is coated. Suitable salts include, for example, those described in EP2100949. Bleach activators are typically organic peracid precursors that enhance the bleaching action in the course of cleaning at temperatures of 60° C. and below. Bleach activators suitable for use herein include compounds which, under perhydrolysis conditions, give aliphatic peroxycarboxylic acids having preferably from about 1 to about 10 carbon atoms, in particular from about 2 to about 4 carbon atoms, and/or optionally substituted perbenzoic acid. Bleach catalysts typically include, for example, manganese triazacyclononane and related complexes, and cobalt, copper, manganese, and iron complexes, as well as those described in U.S. Pat. Nos. 4,246,612, 5,227,084, 4,810,410, WO9906521, and EP2100949.

In some embodiments, the laundry detergent compositions described herein comprise one or more catalytic metal complex. In some embodiments, a metal-containing bleach catalyst finds use. In other embodiments, the metal bleach catalyst comprises a catalyst system comprising a transition metal cation of defined bleach catalytic activity (e.g., copper, iron, titanium, ruthenium, tungsten, molybdenum, or manganese cations), an auxiliary metal cation having little or no bleach catalytic activity (e.g., zinc or aluminum cations), and a sequestrate having defined stability constants for the catalytic and auxiliary metal cations, particularly ethylenediaminetetraacetic acid, ethylenediaminetetra (methylenephosphonic acid) and water-soluble salts thereof are used (See, e.g., U.S. Pat. No. 4,430,243). In some embodiments, the laundry detergent compositions described herein are catalyzed by means of a manganese compound. Such compounds and levels of use are well known in the art (See, e.g., U.S. Pat. No. 5,576,282). In additional embodiments, cobalt bleach catalysts find use in the laundry detergent compositions described herein. Various cobalt bleach catalysts are known in the art (See, e.g., U.S. Pat. Nos. 5,597,936 and 5,595,967) and are readily prepared by known procedures.

Some embodiments are directed to a method of cleaning comprising contacting an effective amount of a cleaning composition described herein with an item or surface comprising a soil or stain to hydrolyze the soil or stain.

Other aspects and embodiments of the present compositions and methods will be apparent from the foregoing description and following examples. Various alternative embodiments beyond those described herein can be employed in practicing the invention without departing from the spirit and scope of the invention. Accordingly, the claims, and not the specific embodiments described herein, define the scope of the invention and as such methods and structures within the scope of the claims and their equivalents are covered thereby.

### Example 1

### Assay for Alpha-Amylase Activity

The Ceralpha alpha-amylase assay is performed using the Ceralpha HR kit (Megazyme, Wicklow, Ireland) as described in WO2014099523. The substrate used is a mixture of the defined oligosaccharide “non-reducing-end blocked p-nitrophenyl maltoheptaoside (BP-NPG7) and excess levels of alpha-glucosidase (which has no activity on the native substrate due to the presence of the ‘blocking group’). The reaction is terminated (and color developed) by the addition of borate buffer. The absorbance at 405 nm is measured, which relates directly to the level of amylase in the sample analyzed. The assay incubation temperature is set at both high (32 or 40° C.) and low (16 or 20° C.) temperatures.

### Example 2

### DMC Assay for Protease Activity

Protease activity can be measured using Dimethyl Casein (DMC). Release of peptides is initiated via protease action. Protease activity is measured in protease units (PUs). 1 PU is the amount of enzyme that hydrolyzes casein such that the initial rate of formation of peptides per minute corresponds to 1 μmole of glycine per minute. 1 KPU is equal to 1000 protease units.

A 2,4,6 Trinitrobenzenesulphonic acid (TNBSA) solution and a DMC solution are prepared. The TNBSA solution is made by dissolving 0.40 mL of TNBSA (Sigma Cat No P-2297) in 50 mL of deionized water. The DMC solution is made by dissolving 5.09 g of Potassium Chloride (Sigma Catalogue No: P-3911) and 1.545 g of Boric Acid (Sigma Catalogue No: B-0399) in 500 mL of deionized water. The solution is stirred for 10 mins to dissolve and then the pH adjusted to 9.0 using 50% NaOH. 2 g of DMC are then added (DMC, British Drug House, Cat No. 79457) and the solution is stirred to dissolve.

100 μL of a dilute enzyme containing sample is added (0.5% sodium sulfite solution with 0.04% calcium chloride; Sigma Catalogue No: S-6672 and Sigma Catalogue No: C-5080, respectively) to 1800 μL of DMC solution. The resultant solution is mixed and incubated. Then, 900 μL of TNBSA solution are added to the mixture and incubated. The absorbance is read at 415 nm. The assay incubation temperature is set at both high (32 or 40° C.) and low (16 or 20° C.) temperatures.

### Example 3

### AAPF Assay for Protease Activity

The protease activity is measured using the succinyl-L-alanyl-L-alanyl-L-prolyl-L-phenyl-p-nitroanilide substrate (suc-AAPF-pNA, Sigma: S-7388) at pH 8.6 buffer as described in WO2012151534. The reagent solutions used were: 100 mM Tris/HCl, pH 8.6, containing 0.005% TWEEN®-80 (Tris dilution buffer); 100 mM Tris buffer, pH 8.6, containing 10 mM CaCl₂) and 0.005% TWEEN®-80 (Tris/Ca buffer); and 160 mM suc-AAPF-pNA in DMSO (suc-AAPF-pNA stock solution) (Sigma: S-7388). The absorbance at 405 nm was measured, which relates directly to the level of protease in the sample analyzed. The assay incubation temperature is set at both high (32 or 40° C.) and low (16 or 20° C.) temperatures.

### Example 4

### Assay for Mannanase Activity

The mannanase activity was tested by measuring the hydrolysis of locust bean gum (LBG) galactomannan in solution. The substrate used was 0.28% (w/v) LBG solution in 50 mM Tris-HCl buffer, pH 7.5 (substrate dilution buffer). To prepare a working substrate solution, the LBG powder (Product No. G0753, Sigma-Aldrich, St. Louis, Mo.) was dissolved in a heated solution of 50 mM Tris-HCl buffer, pH 7.5, under stirring. Upon cooling to room temperature, the solution was centrifuged and the clear supernatant was used as the substrate solution. Enzyme samples were diluted into enzyme dilution buffer (50 mM MOPS buffer, pH 7.2, containing 0.005% TWEEN®-80) and aliquots of the diluted enzyme solutions were added to a flat-bottom clear polystyrene MTP containing the LBG substrate solution. The plate was sealed and incubated at both high (32 or 40° C.) and low (16 or 20° C.) temperature with agitation at 900 rpm for 10 min (e.g. in an iEMS incubator/shaker, Thermo Fisher Scientific, Waltham, Mass.). After the incubation, the released reducing sugars were quantified using the BCA reagent assay (Catalog No. 23225, Thermo Scientific Pierce, Rockford, Ill.). Specifically, aliquots from each well of the LBG assay plate were added to a PCR plate containing BCA working reagent solution (prepared according to the manufacturer's instructions); the sample to working reagent ratio was 1:9 (v/v). The plates were sealed and incubated in a thermocycler (e.g. Tetrad2 Peltier Thermal Cycler, Bio-Rad Laboratories, Hercules, Calif.) at 95° C. for 2-3 min. After the plate cooled to 30° C., the reaction solution was transferred to a fresh flat-bottom clear polystyrene MTP (e.g. Costar 9017) and absorbance was measured at 562 nm in a plate reader spectrophotometer (e.g. SpectraMax Plus 384, Molecular Devices, Sunnyvale, Calif.). The absorbance value of a sample not containing mannanase (blank) was subtracted from the absorbance values of the mannanase-containing samples. The resulting absorbance was taken as a measure of mannanase activity.

SEQUENCE LISTING
SEQ ID NO: 1:
MATGFYVSGNKLYDSTGKPFVMRGVNHGHSWFKNDLNTAIPAIAKTGANTVRIVLSNG
SLYTKDDLNAVKNIINVVNQNKMIAVLEVHDATGKDDYNSLDAAVNYWISIKEALIGK
EDRVIVNIANEWYGTWNGSAWADGYKKAIPKLRNAGIKNTLIVDAAGWGQFPQSIVD
YGQSVFAADSQKNTVFSIHMYEYAGKDAATVKANMENVLNKGLALIIGEFGGYHTNG
DVDEYAIMRYGQEKGVGWLAWSWYGNSSGLNYLDMATGPNGSLTSFGNTVVNDTYG
IKNTSQKAGIF
SEQ ID NO: 2:
HHNGTNGTMMQYFEWYLPNDGNHWNRIRSDASNLKDKGISAVWIPPAWKGASQNDV
GYGAYDLYDLGEFNQKGTIRTKYGTRNQLQAAVNALKSNGIQVYGDVVMNHKGGAD
ATEMVRAVEVNPNNRNQEVSGEYTIEAWTKFDFPGRGNTHSNFKWRWYHFDGVDWD
QS RKLNNRIYKFRGDGKGWDWE VDTENGNYDY LMYADIDMDH PEVVNELRNW
GVWYTNTLGLDGFRIDAVKHIKYSFTRDWINHVRSATGKNMFAVAEFWKNDLGAIEN
YLNKTNWNHSVFDVPLHYNLYNASKSGGNYDMRQIFNGTVVQRHPMHAVTFVDNHD
SQPEEALESFVEEWFKPLAYALTLTREQGYPSVFYGDYYGIPTHGVPAMKSKIDPILEAR
QKYAYGRQNDYLDHHNIIGWTREGNTAHPNSGLATIMSDGAGGNKWMFVGRNKAGQ
VWTDITGNRAGTVTINADGWGNFSVNGGSVSIWVNK
SEQ ID NO: 3:
HHNGTNGTMMQYFEWHLPNDGNHWNRLRDDASNLRNRGITAIWIPPAWKGTSQNDV
GYGAYDLYDLGEFNQKGTVRTKYGTRSQLESAIHALKNNGVQVYGDVVMNHKGGAD
ATENVLAVEVNPNNRNQEISTGDYTIEAWTRFDFPGRGNTYSDFKWRWYHFDGVDWDQ
SRQFQNRIYKFRGDGKAWDWEVDSENGNYDYLMYADVDMDHPEVVNELRRWGEWY
TNTLNLDGFRIDAVKHIKYSFTRDWLTHVRNATGKEMFAVAEFWKNDLGALENYLNK
TNWNHSVFDVPLHYNLYNASNSGGNYDMAKLLNGTVVQKHPMHAVTFVDNHDSQPG
ESLESFVQEWFKPLAYALILTREQGYPSVFYGDYYGIPTHSVPAMKAKIDPILEARQNFA
YGTQHDYFDHHNIIGWTREGNTTHPNSGLATIMSDGPGGEKWMYVGQNKAGQVWHD
ITGNKPGTVTINADGWANFSVNGGSVSIWVKR
SEQ ID NO: 4:
HHNGTNGTMMQYFEWYLPNDGNHWNRLNSDASNLKSKGITAVWIPPAWKGASQNDV
GYGAYDLYDLGEFNQKGTVRTKYGTRSQLQAAVTSLKNNGIQVYGDVVMNHKGGAD
ATEMVRAVEVNPNNRNQEVTGEYTIEAWTRFDFPGRGNTHSSFKWRWYHFDGVDWD
QSRRLNNRIYKFRGHGKAWDWEVDTENGNYDYLMYADIDMDHPEVVNELRNWGVW
YTNTLGLDGFRIDAVKHIKYSFTRDWINHVRSATGKNMFAVAEFWKNDLGAIENYLQK
TNWNHSVFDVPLHYNLYNASKSGGNYDMRNIFNGTVVQRHPSHAVTFVDNHDSQPEE
ALESFVEEWFKPLAYALTLTREQGYPSVFYGDYYGIPTHGVPAMRSKIDPILEARQKYA
YGKQNDYLDHHNIIGWTREGNTAHPNSGLATIMSDGAGGSKWMFVGRNKAGQVWSD
ITGNRTGTVTINADGWGNFSVNGGSVSIWVNK
SEQ ID NO: 5:
VNGTLMQYFEWYTPNDGQHWKRLQNDAEHLSDIGITAVWIPPAYKGLSQSDNGYGPY
DLYDLGEFQQKGTVRTKYGTKSELQDAIGSLHSRNVQVYGDVVLNHKAGADATEDVT
AVEVNPANRNQETSEEYQIKAWTDFRFPGRGNTYSDFKWHWYHFDGADWDESRKISRI
FKFRGEGKAWDWEVSSENGNYDYLMYADVDYDHPDVVAETKKWGIWYANELSLDG
FRIDAAKHIKFSFLRDWVQAVRQATGKEMFTVAEYWQNNAGKLENYLNKTSFNQSVF
DVPLHFNLQAASSQGGGYDMRRLLDGTVVSRHPEKAVTFVENHDTQPGQSLESTVQT
WFKPLAYAFILTRESGYPQVFYGDMYGTKGTSPKEIPSLKDNIEPILKARKEYAYGPQH
DYIDHPDVIGWTREGDSSAAKSGLAALITDGPGGSKRMYAGLKNAGETWYDITGNRSD
TVKIGSDGWGEFHVNDGSVSIYVQK
SEQ ID NO: 6:
HHNGTNGTMMQYFEWYLPNDGNHWNRLNSDASNLKSKGITAVWIPPAWKGASQNDV
GYGAYDLYDLGEFNQKGTVRTKYGTRSQLQAAVTSLKNNGIQVYGDVVMNHKGGAD
ATEMVRAVEVNPNNRNQEVTGEYTIEAWTRFDFPGRGNTHSSFKWRWYHFDGVDWD
QSRRLNNRIYKFRGKAWDWEVDTENGNYDYLMYADIDMDHPEVVNELRNWGVWYT
NTLGLDGFRIDAVKHIKYSFTRDWINHVRSATGKNMFAVAEFWKNDLGAIENYLQKTN
WNHSVFDVPLHYNLYNASKSGGNYDMRNIFNGTVVQRHPSHAVTFVDNHDSQPEEAL
ESFVEEWFKPLAYALTLTREQGYPSVFYGDYYGIPTHGVPAMRSKIDPILEARQKYAYG
PQHDYLDHPDVIGWTREGDSSHPKSGLATLITDGPGGSKRMYAGLKNAGETWYDITGN
RSDTVKIGSDGWGEFHVNDGSVSIYVQK
SEQ ID NO: 7:
ANLNGTLMQYFEWYMPNDGQHWRRLQNDSAYLAEHGITAVWIPPAYKGTSQADVGY
GAYDLYDLGEFHQKGTVRTKYGTKGELQSAIKSLHSRDINVYGDVVINHKGGADATED
VTAVEVDPADRNRVISGEHRIKAWTHFHFPGRGSTYSDFKWHWYHFDGTDWDESRKL
NRIYKFQGKAWDWEVSNENGNYDYLMYADIDYDHPDVAAEIKRWGTWYANELQLD
GFRLDAVKHIKFSFLRDWVNHVREKTGKEMFTVAEYWQNDLGALENYLNKTNFNHSV
FDVPLHYQFHAASTQGGGYDMRKLLNSTVVSKHPLKAVTFVDNHDTQPGQSLESTVQ
TWFKPLAYAFILTRESGYPQVFYGDMYGTKGDSQREIPALKHKIEPILKARKQYAYGAQ
HDYFDHHDIVGWTREGDSSVANSGLAALITDGPGGAKRMYVGRQNAGETWHDITGNR
SEPVVINSEGWGEFHVNGGSVSIYVQR
SEQ ID NO: 8:
AATNGTMMQYFEWYVPNDGQQWNRLRTDAPYLSSVGITAVWTPPAYKGTSQADVGY
GPYDLYDLGEFNQKGTVRTKYGTKGELKSAVNTLHSNGIQVYGDVVMNHKAGADYT
ENVTAVEVNPSNRNQETSGEYNIQAWTGFNFPGRGTTYSNFKWQWFHFDGTDWDQSR
SLSRIFKFRGTGKAWDWEVSSENGNYDYLMYADIDYDHPDVVNEMKKWGVWYANE
VGLDGYRLDAVKHIKFSFLKDWVDNARAATGKEMFTVGEYWQNDLGALNNYLAKVN
YNQSLFDAPLHYNFYAASTGGGYYDMRNILNNTLVASNPTKAVTLVENHDTQPGQSLE
STVQPWFKPLAYAFILTRSGGYPSVFYGDMYGTKGTTTREIPALKSKIEPLLKARKDYA
YGTQRDYIDNPDVIGWTREGDSTKAKSGLATVITDGPGGSKRMYVGTSNAGEIWYDLT
GNRTDKITIGSDGYATFPVNGGSVSVWVQQ
SEQ ID NO: 9:
ADNGTIMQYFEWYLPNDGAHWNRLNNDAQNLKNVGITAVWIPPAYKGGSSADVGYG
VYDTYDLGEFNQKGTVRTKYGTKSELISAVNNLHAKGIAVYGDVVLNHRMNADATEL
VDAVEVDPNNRNVETTSTYQIQAWTQYDFPGRGNTYSSFKWRWYHFDGVDWDQSRG
LNRIYKLRGDGKDWDWEVDSEYGNYDYLMGADLDFNHPDVVNETKTWGKWFVNTV
NLDGVRLDAVKHIKFDFMRDWVNNVRSTTGKNLFAVGEYWHYDVNKLNSYITKTNG
TMSLFDVPLHFRFYDASNGGGGYDMRNLLNNTLMSSNPMKAVTFVENHDTQPTQALQ
STVQSWFKPLAYATILTREQGYPCVFYGDYYGTSDGKISSYKPIMDKLLNARKVYAYG
TQRDYFDHPDIVGWTREGDAAHAGSGLATLITDGPGGSKWMYVGTSKAGQVWTDKT
GNRSGTVTIDANGWGNFWVNGGSVSVWAK
SEQ ID NO: 10:
NTAPINETMMQYFEWDLPNDGTLWTKVKNEAANLSSLGITALWLPPAYKGTSQSDVG
YGVYDLYDLGEFNQKGTIRTKYGTKTQYIQAIQAAKAAGMQVYADVVFNIIKAGADG
TEFVDAVEVDPSNRNQETSGTYQIQAWTKFDFPGRGNTYSSFKWRWYHFDGTDWDES
RKLNRIYKFRSTGKAWDWEVDTENGNYDYLMFADLDMDHPEVVTELKNWGTWYVN
TTNIDGFRLDAVKHIKYSFFPDWLTYVRNQTGKNLFAVGEFWSYDVNKLHNYITKTNG
SMSLFDAPLHNNFYTASKSSGYFDMRYLLNNTLMKDQPSLAVTLVDNHDTQPGQSLQS
WVEPWFKPLAYAFILTRQEGYPCVFYGDYYGIPKYNIPGLKSKIDPLLIARRDYAYGTQ
RDYIDHQDIIGWTREGIDTKPNSGLAALITDGPGGSKWMYVGKKHAGKVFYDLTGNRS
DTVTINADGWGEFKVNGGSVSIWVAK
SEQ ID NO: 11:
ANSGFYVSGTTLYDANGNPFVMRGINHGHAWYKDQATTAIEGIANTGANTVRIVLSDG
GQWTKDDIHTVRNLISLAEDNHLVAVLEVHDATGYDSIASLNRAVDYWIEMRSALIGK
EDTVIINIANEWFGSWEGDAWADGYKQAIPRLRNAGLNHTLMVDAAGWGQFPQSIHD
YGREVFNADPQRNTMFSIHMYEYAGGNASQVRTNIDRVLNQDLALVIGEFGHRHTNGD
VDEATIMSYSEQRGVGWLAWSWKGNGPEWEYLDLSNDWAGNNLTAWGNTIVNGPY
GLRETSRLSTVFTGGGSDGGTSP
SEQ ID NO: 12:
GFSVDGNTLYDANGQPFVMRGINHGHAWYKDTASTAIPAIAEQGANTIRIVLSDGGQW
EKDDIDTIREVIELAEQNKMVAVVEVHDATGRDSRSDLNRAVDYWIEMKDALIGKEDT
VIINIANEWYGSWDGSAWADGYIDVIPKLRDAGLTHTLMVDAAGWGQYPQSIHDYGQ
DVFNADPLKNTMFSIHMYEYAGGDANTVRSNIDRVIDQDLALVIGEFGHRHTDVDEDTI
LSYSEETGTGWLAWSWKGNSTSWDYLDLSEDWAGQHLTDWGNRIVHGADGLQETSK
PSTVF
SEQ ID NO: 13:
ANSGFYVSGTTLYDANGNPFVMRGINHGHAWYKDQATTAIEGIANTGANTVRIVLSDG
GQWTKDDIHTVRNLISLAEDNHLVAVPEVHDATGYDSIASLNRAVDYWIEMRSALIGK
EDTVIINIANEWFGSWEGDAWADGYKQAIPRLRNAGLNHTLMVDAAGWGQFPQSIHD
YGREVFNADPQRNTMFSIHMYEYAGGNASQVRTNIDRVLNQDLALVIGEFGHRHTNGD
VDEATIMSYSEQRGVGWLAWSWKGNGPEWEYLDLSNDWAGNNLTAWGNTIVNGPY
GLRETSRLSTVFT
SEQ ID NO: 14:
ANSGFYVSGTTLYDANGNPFVMRGINHGHAWYKDQATTAIEGIANTGANTVRIVLSDG
GQWTKDDIHTVRNLISLAEDNHLVAVPEVHDATGYDSIASLNRAVDYWIEMRSALIGK
EDTVIINIANEWFGSWEGDAWADGYKQAIPRLRNAGLNHTLMVDAAGWGQFPQSIHD
YGREVFNADPQRNTMFSIHMYEYAGGNASQVRTNIDRVLNQDLALVIGEFGHRHTNGD
VDEATIMSYSEQRGVGWLAWSWKGNGPEWEYLDLSNDWAGNNLTAWGNTIVNGPY
GLRETSRLSTVFTGGGSDGGTSP
SEQ ID NO: 15:
NSGFYVSGTTLYDANGNPFVMRGINHGHAWYKDQATTAIEGIANTGANTVRIVLSDGG
QWTKDDIQTVRNLISLAEDNNLVAVLEVHDATGYDSIASLNRAVDYWIEMRSALIGKE
DTVIINIANEWFGSWDGAAWADGYKQAIPRLRNAGLNNTLMIDAAGWGQFPQSIHDY
GREVFNADPQRNTMFSIHMYEYAGGNASQVRTNIDRVLNQDLALVIGEFGHRHTNGDV
DESTIMSYSEQRGVGWLAWSWKGNGPEWEYLDLSNDWAGNNLTAWGNTIVNGPYGL
RETSKLSTVFTG
SEQ ID NO: 16:
ASGFYVSGTILCDSTGNPFKIRGINHAHSWFKNDSATAMEAIAATGANTVRIVLSNGQQ
YAKDDANTVSNLLSLANQHKLIAILEVHDATGSDSVSALDHAVDYWIEMKNVLVGKE
DRVLINIANEWYGTWDSNGWADGYKSAIPKLRNAGINHTLIVDAAGWGQYPQSIVDK
GNEVFNSDPLRNTIFSIHMYEYAGGNADMVRANIDQVLNKGLAVIIGEFGHYHTGGDV
DETAIMSYTQQKGVGWLAWSWKGNGAEWLYLDLSYDWAGNHLTEWGETIVNGANG
LKATSTRAPIFGN
SEQ ID NO: 17:
AQSVPYGVSQIKAPALHSQGYTGSNVKVAVIDSGIDSSHPDLKVAGGASMVPSETNPFQ
DNNSHGTHVAGTVAALNNSIGVLGVAPSASLYAVKVLGADGSGQYSWIINGIEWAIAN
NMDVINMSLGGPSGSAALKAAVDKAVASGVVVVAAAGNEGTSGSSSTVGYPGKYPSVI
AVGAVDSSNQRASFSSVGPELDVMAPGVSIQSTLPGNKYGAYNGTSMASPHVAGAAAL
ILSKHPNWTNTQVRSSLENTTTKLGDSFYYGKGLINVQAAAQKSFPEVVGKTVDQAREY
FTLHYPQYDVYFLPEGSPVTLDLRYNRVKVFYNPGTNVVNHVPHVG
SEQ ID NO: 18:
AQSVPWGISRVQAPAAHNRGLTGSGVKVAVLDTGISTHPDLNIRGGASFVPGEPSTQDG
NGHGTHVAGTIAALNNSIGVLGVAPSAELYAVKVLGASGSGSVSSIAQGLEWAGNNGM
HVANLSLGSPSPSATLEQAVNSATSRGVLVVAASGNSGAGSISYPARYANAMAVGATDQ
NNNRASFSQYGAGLDIVAPGVNVQSTYPGSTYASLNGTSMATPHVAGAAALVKQKNPS
WSNVQIRNHLKNTATSLGSTNLYGSGLVNAEAATR
SEQ ID NO: 19:
AQTVPYGIPLIKADKVQAQGFKGANVKVAVLDTGIQASHPDLNVVGGASFVAGEAYNT
DGNGHGTHVAGTVAALDNTTGVLGVAPSVSLYAVKVLNSSGSGSYSGIVSGIEWATTN
GMDVINMSLGGASGSTAMKQAVDNAYARGVVVVAAAGNSGSSGNTNTIGYPAKYDS
VIAVGAVDSNSNRASFSSVGAELEVMAPGAGVYSTYPTNTYATLNGTSMASPHVAGAA
ALILSKHPNLSASQVRNRLSSTATYLGSSFYYGKGLINVEAAAQ

We claim:

1. A laundry detergent composition comprising:
(a) at least 0.5 or 1 ppm of one or more active low temperature mannanase; and
(b) (i) at least 2 or 4 ppm of one or more active low temperature amylase, and/or (ii) at least 5 or 10 ppm of one or more active low temperature protease.

2. A laundry detergent composition according to claim 1, wherein said active low temperature mannanase is a mannanase variant, or a recombinant polypeptide or an active fragment thereof comprising an amino acid sequence comprising one, two, three, four, five, six, seven or more variations versus SEQ ID NO:1 at one, two, three, four, five, six, seven or more positions selected from:
(i) 10, 19, 30, 38, 59, 60, 62, 63, 66, 67, 68, 70, 71, 74, 75, 78, 79, 80, 85, 97, 103, 129, 131, 135, 136, 143, 167, 168, 184, 213, 214, 225, 228, 235, 242, 244, 258, 259, 261, and 283;
(ii) 19, 38, 67, 85, 97, 129, 143, 168, 184, 225, 228, 235, 244, 258, and 261; or
(iii) 19, 38, 67, 85, 129, 168, 184, 225, 244, 258, and 261; with the proviso that one or more of said variations is non-naturally occurring; and wherein the amino acid positions of said mannanase variant or recombinant polypeptide or active fragment thereof are numbered by correspondence with the amino acid sequence of SEQ ID NO:1.

3. The laundry detergent composition according to claim 1 or 2, wherein said mannanase variant or recombinant polypeptide or active fragment thereof comprises one, two, three, four, five, six, seven or more variations versus SEQ ID NO:1 selected from:
(i) 10Q/T, 19E/V, 30T, 38E/I/L/M/Q/R/V, 59D/G/K/N/Q/T, 60F/M/V, 62E/I/Q/V, 63L, 66C/T/V, 67A/D/E/G/P/Q/S/V, 68L/M/R/S/W, 70R/V, 71D/H, 74E/C/Q/V, 75I, 78A/D/L/M, 79E/F/W, 80Q/T, 85L, 97E/L/P/Q, 103I, 129M, 131P, 135A/C/Q, 136E, 143Q/R, 167L/S/W/Y, 168A/E/G/L/M/S/T, 184D/F/H/L/M/P, 213E, 214C/Q, 225A/C/P/W, 228A/G/H/I/K/S/V/Y, 235G/I/L/Q/S/V, 242S/E, 244A/C/G/L/M/P/S, 258A/D/E/G/M/N/P/T, 259A/E/R/S/W, 261I/M/P/Q/R/S/T/V/W/Y, and 283G/H/T;
(ii) 19E/V, 38E/I/L/M/Q/R/V, 67A/D/E/G/P/Q/S/V, 85L, 97E/L/P/Q, 129M, 143Q/R, 168A/E/G/L/M/S/T, 184D/F/H/L/M/P, 225A/C/P/W, 228A/G/H/I/K/S/V/Y, 235G/I/L/Q/S/V, 244A/C/G/L/M/P/S, 258A/D/E/G/M/N/P/T, and 261I/M/P/Q/R/S/T/V/W/Y;
(iii) 19E/V, 38E/I/L/M/Q/R/V, 67A/D/E/G/P/Q/S/V, 85L, 129M, 168A/E/G/L/M/S/T, 184D/F/H/L/M/P, 225A/C/P/W, 244A/C/G/L/M/P/S, 258A/D/E/G/M/N/P/T, and 261I/M/P/Q/R/S/T/V/W/Y; or
(iv) 19E, 30T, 38E, 59V, 60Q, 63R, 67D, 85L, 97D, 103I, 129M, 167Y, 168S, 184L, 225C, 228V, 235L, 244L, 258D, and 261R; with the proviso that one or more of said variations is non-naturally occurring; and wherein the amino acid positions of said mannanase variant or recombinant polypeptide or active fragment thereof are numbered by correspondence with the amino acid sequence of SEQ ID NO:1.

4. The laundry detergent composition according to any preceding claim, wherein said mannanase variant or recombinant polypeptide or active fragment thereof comprises two, three, four, five, six, seven or more variations versus SEQ ID NO:1 selected from:
(i) N/T10Q/T, P19E/V, A/S30T, T38E/I/L/M/Q/R/V, G/S59D/G/K/N/Q/T, L/Q60F/M/V, E/T62E/I/Q/V, K63R, I/L66C/T/V, D/H/N67A/D/E/G/P/Q/S/V, A/T68L/M/R/S/W, K/R70R/V, E/N71D/H, E/N/S74E/C/Q/V, L/V75I, D/Q78A/D/L/M, N79E/F/W, H/K80Q/T, P/V85L, A/N/S97E/L/P/Q, V103I, F/Y129M, S/T131P, D/S135A/C/Q, A136E, D/K/Q143Q/R, F/Y167L/S/W/Y, P168A/E/G/L/M/S/T, L/Q184D/F/H/L/M/P, D/N213E, K/Q214C/Q, G/H225A/C/P/W, T228A/G/H/I/K/S/V/Y, A/D/Y235G/I/L/Q/S/V, E/Q242S/E, K/R/Y244A/C/G/L/M/P/S, P/S/T258A/D/E/G/M/N/P/T, E/G/S259A/E/R/S/W, D/E/N261I/M/P/Q/R/S/T/V/W/Y, and D/G283G/H/T;
(ii) P19E/V, T38E/I/L/M/Q/R/V, D/H/N67A/D/E/G/P/Q/S/V, P/V85L, A/N/S97E/L/P/Q, F/Y129M, D/K/Q143Q/R, P168A/E/G/L/M/S/T, L/Q184D/F/H/L/M/P, G/H225A/C/P/W, T228A/G/H/I/K/S/V/Y, A/D/Y235G/I/L/Q/S/V, K/R/Y244A/C/G/L/M/P/S, P/S/T258A/D/E/G/M/N/P/T, and D/E/N261I/M/P/Q/R/S/T/V/W/Y;
(iii) P19E/V, T38E/I/L/M/Q/R/V, D/H/N67A/D/E/G/P/Q/S/V, P/V85L, F/Y129M, P168A/E/G/L/M/S/T, L/Q184D/F/H/L/M/P, G/H225A/C/P/W, K/R/Y244A/C/G/L/M/P/S, P/S/T258A/D/E/G/M/N/P/T, and D/E/N261I/M/P/Q/R/S/T/V/W/Y; or
(iv) P19E, A/S30T, T38E, G/S59V, L60Q, K63R, H/N67D, P/V85L, A/N/S97D, V103I, F/Y129M, F167Y, P168S, Q184L, G/H225C, T228V, A/D/Y235L, K/R/Y244L, P/S/T258D, and D/E/N261R with the proviso that one or more of said variations is non-naturally occurring; and wherein the amino acid positions of said mannanase variant or recombinant polypeptide or active fragment thereof are numbered by correspondence with the amino acid sequence of SEQ ID NO:1.

5. The laundry detergent composition according to any preceding claim, wherein said mannanase variant or recombinant polypeptide or active fragment thereof comprises a combination of substitutions in SEQ ID NO:1 selected from P19E-T38E-N67D-N97D-Y129M-P168S-Q184L-K244L-S258D-N261R; N10T-P19E-G28S-S30T-T38E-N67D-N71D-N97D-Y129M-P168S-Q184L-G225C-Y235L-K244L-S258D-N261R-Z298.01Q; P19E-S30T-T38E-S59V-L60Q-K63R-N67D-N97D-V103I-Y129M-F167Y-Q184L-G225C-T228V-Y235L-K244L-S258D-N261R-Z298.01Q; N10T-P19E-S30T-T38E-S59V-L60Q-K63R-N67D-N97D-Y129M-K143Q-P168S-Q184L-G225C-T228V-Y235L-K244L-S258D-N261R-Z298.01Q; N10 T-P19E-S30 T-T38E-S59V-L60Q-K63R-N67D-N97D-Y129M-K143Q-P168S-Q184L-G225P-T228V-Y235L-K244L-S258D-N261R-Z298.01Q; N10T-P19E-S30T-T38E-S59V-L60Q-K63R-N67D-N71D-N97D-V103I-Y129M-K143Q-P168S-Q184L-G225P-T228V-Y235L-K244L-S258D-N261R-Z298.01Q; A2S-P19E-G28S-S30T-T38E-K63R-N67D-N71D-N74E-K93R-N97D-Y129M-N150T-P168S-Q184L-N213A-G225C-Y235L-K244L-S258D-N261Q-Z298.01Q; T3R-N10T-P19E-G28A-S30T-T38E-T62E-N67D-N71D-K93R-N97L-E111S-Y129M-D139M-P168S-Q184L-G225C-Y235L-K244L-S258D-N261Q-Z298.01Q; and N10 T-P19E-G28A-S30 T-T38E-S59D-N67D-A68S-N71D-K93R-N97D-Y129M-K143Q-P168S-Q184D-G225C-Y235L-K244L-S258D-N261R-T284E-Z298.01Q; and wherein the amino acid positions of said mannanase variant or recombinant polypeptide or active fragment thereof are numbered by correspondence with the amino acid sequence of SEQ ID NO:1.

6. The laundry detergent composition according to any preceding claim, wherein said low temperature amylase is an amylase variant comprising an amino acid sequence comprising:
(i) one or more substitutions in SEQ ID NO:2 selected from 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, and, optionally, one or more deletion at one or more position in SEQ ID NO:2 selected from 183 and 184;
(ii) one or more deletions at one or more positions in SEQ ID NO:3 selected from 183 and 184, wherein said variant has at least 90% amino acid sequence identity to the amino acid sequence of SEQ ID NO:3;
(iii) an A and B domain and a C domain, wherein the A and B domain is at least 75%, 80%, 85%, 90%, 91%, 92%, 93%, 94%, 95%, 96%, 97%, 98%, 99%, or 100% identical to the polypeptide with the amino acid sequence of residues 1-399 of SEQ ID NO:4, which is used for numbering, and the C domain is at least 75% 80%, 85%, 90%, 91%, 92%, 93%, 94%, 95%, 96%, 97%, 98%, 99%, or 100% identical to the polypeptide with the amino acid sequence of residues 398-483 of SEQ ID NO:5, which is used for numbering, wherein the A and B domain, optionally, comprises a deletion of two or more amino acids corresponding to positions 181, 182, 183, and 184 of the amino acid sequence of SEQ ID NO:4, and wherein the C domain, optionally, comprises one or more substitutions selected from I403L, A419H, A420P, and A426T;
(iv) at least 95% identity with SEQ ID NO:4 and one or more substitutions in SEQ ID NO:4 selected from M202, M208, S255, R172 and M261, optionally wherein at least one of said substitutions is M202, and wherein SEQ ID NO:4 is used for numbering;
(v) a substitution at an amino acid residue corresponding to R375 and, optionally, S360 of SEQ ID NO:8, and one or two or more substitutions at one or more amino acid residues corresponding to amino acid residues in SEQ ID NO:8 selected from N126, F153, T180, E187, and I203, wherein said variant has at least 60%, 70%, 80%, 85%, 90% or 95% amino acid sequence identity to SEQ ID NO:8, and wherein SEQ ID NO:8 is used for numbering;
(vi) one or two or more substitutions at one or more amino acid residue corresponding to amino acid residues in SEQ ID NO:8 selected from T38, N126, F153, T180, E187, I203, G476, and G477, and, optionally, one or more deletion at one or more amino acid residues corresponding to amino acid residues in SEQ ID NO:8 selected from R178, G179, T180, and G181, wherein said variant has at least 60%, 70%, 80%, 85%, 90% or 95% amino acid sequence identity to SEQ ID NO:8, and wherein SEQ ID NO:8 is used for numbering;
(vii) two substitutions at amino acid residue corresponding to E187 and 1203 of SEQ ID NO:8, and, optionally, one or more substitutions at one or more amino acid residues corresponding to amino acid residues in SEQ ID NO:8 selected from R458, T459, D460, and G476, and, optionally, one or more deletion at one or more amino acid residues corresponding to amino acid residues in SEQ ID NO:8 selected from R178, G179, T180, and G181, wherein said variant has at least 60%, 70%, 80%, 85%, 90% or 95% amino acid sequence identity to SEQ ID NO:8, and wherein SEQ ID NO:8 is used for numbering;
(viii) a combination of substitutions in SEQ ID NO:9 selected from N125Y/E186P/T333G/A335S/Q337E/G472K, N125Y/F152W/E186P/T333G/A335S/Q337E/G472K, N125Y/F152W/E186P/T333G/A335S/Q337E/G472R/G473R, N125Y/F152W/E186P/N205D/T333G/A335S/Q337E/G472K, N125Y/E186P/T333G/A335S/G472K, N125Y/F152W/E186P/T333G/A335S/G472K, N125Y/F152W/E186P/T333G/A335S/G472R/G473R, N125Y/F152W/E186P/N205D/T333G/A335S/G472K, N125Y/E186P/T333G/G472K, N125Y/F152W/E186P/T333G/G472K, N125Y/F152W/E186P/T333G/G472R/G473R, and N125Y/F152W/E186P/N205D/T333G/G472K, and, optionally, one or more deletions of one or more amino acid residues corresponding to amino acid residues in SEQ ID NO:9 selected from R178, G179, T180, and G181, wherein said variant has at least 60%, 70%, 80%, 85%, 90% or 95% amino acid sequence identity to SEQ ID NO:9; or
(ix) comprising a substitution at one or more positions selected from 83, 125, 128, 131, 160, 178, 182, 183, 185, 189, 279, 305, 319, 320, 379, 407, 433, 453, 475, 476, and 483, and, optionally, a substitution at position 243 and/or a deletion at position 180 and/or position 181, wherein the positions correspond to amino acid residues in the amino acid sequence set forth in SEQ ID NO:10, and wherein the variant has at least 90% amino acid sequence identity to SEQ ID NO: 10.

7. The laundry detergent composition according to claim 6, wherein said amylase variant comprises an amino acid sequence comprising:
(i) one, two or three or more substitutions in SEQ ID NO:2 selected from 9, 26, 149, 182, 186, 202, 257, 295, 299, 323, 339, and 345, and, optionally, one or more deletions in SEQ ID NO:2 at positions selected from 183 and 184;
(ii) at least 90% amino acid sequence identity to the amino acid sequence of SEQ ID NO:3, wherein said variant further comprises deletions in SEQ ID NO:3 of position 183 and 184;
(iii) at least 80%, 85%, 90%, 95%, or 100% identity to SEQ ID NO:6;
(iv) at least 95% identity with SEQ ID NO:4 and one or more substitutions in SEQ ID NO:4 selected from M202L, M202V, M202S, M202T, M202I, M202Q, M202W, S255N, and R172Q, and wherein SEQ ID NO:4 is used for numbering;
(v) a substitution at an amino acid residue corresponding to R375Y and, optionally, S360A of SEQ ID NO:8, and one or two or more substitutions at one or more amino acid residues corresponding to amino acid residues in SEQ ID NO:8 selected from N126Y, F153W, T180H, E187P, and I203Y, and, optionally, one or more deletion of one or more amino acid residues corresponding to amino acid residues in SEQ ID NO:8 selected from R178, G179, T180, and G181, and wherein SEQ ID NO:8 is used for numbering;
(vi) one or two or more substitutions at one or more amino acid residues corresponding to amino acid residues in SEQ ID NO:8 selected from T38N, N126Y, F153W, E187P, I203Y, G476K, and G477E, and, optionally, a deletion of amino acid residues corresponding to R178 and G179 of SEQ ID NO:8, or T180 and G181 of SEQ ID NO:8, wherein SEQ ID NO:8 is used for numbering;
(vii) two substitutions at amino acid residues corresponding to E187P and I203Y of SEQ ID NO:8, and, optionally, one or more substitutions at one or more amino acid residues corresponding to amino acid residues in SEQ ID NO:8 selected from R458N, T459S, D460T, and G476K, and, optionally, a deletion of amino acid residues corresponding to R178 and G179 of SEQ ID NO:8, or T180 and G181 of SEQ ID NO:8, wherein said variant has at least 60%, 70%, 80%, 85%, 90% or 95% amino acid sequence identity to SEQ ID NO:8, and wherein SEQ ID NO:8 is used for numbering; or
(viii) comprising the combination of substitutions S243Q/G475K and a deletion at position R180 and 5181, wherein the positions correspond to amino acid residues in the amino acid sequence set forth in SEQ ID NO:10, and wherein the variant has at least 90% amino acid sequence identity to SEQ ID NO:10.

8. The laundry detergent composition according to any preceding claim, wherein said low temperature protease is a subtilisin protease variant comprising an amino acid sequence comprising two, three, or four or more variations versus SEQ ID NO:19 at positions selected from:
(i) 1, 3, 9, 10, 15, 17, 19, 22, 24, 25, 26, 27, 28, 30, 35, 37, 38, 43, 45, 48, 68, 71, 74, 76, 77, 78, 86, 87, 91, 95, 96, 98, 99, 100, 102, 103, 108, 111, 114, 115, 120, 123, 125, 126, 127, 128, 129, 130, 136, 143, 146, 147, 151, 155, 160, 165, 183, 184, 187, 193, 202, 203, 210, 217, 234, 238, 239, 240, 242, 247, 250, 251, 255, 258, 259, 260, and 274;
(ii) 1, 3, 9, 15, 22, 24, 28, 30, 35, 37, 45, 48, 68, 71, 74, 76, 77, 78, 86, 87, 95, 96, 98, 99, 100, 108, 114, 115, 120, 123, 125, 126, 127, 128, 129, 130, 143, 146, 147, 151, 155, 165, 183, 184, 187, 193, 202, 203, 210, 217, 234, 238, 239, 240, 242, 247, 250, 255, 258, 259, 260, and 274;
(iii) 1, 3, 15, 35, 68, 71, 77, 86, 87, 95, 99, 115, 123, 127, 128, 147, 155, 165, 184, 202, 210, 217, 234, 239, 242, 250, 258, and 274; or
(iv) 3, 68, 77, 86, 99, 115, 123, 127, 128, 165, 184, 202, 210, 217, and 258;
with the proviso that one or more of said two, three, or four or more variations is a non-naturally occurring amino acid; wherein said variant has 85% or more amino acid sequence identity to the amino acid sequence of SEQ ID NO:19; and wherein the amino acid positions of the variant are numbered by correspondence with the amino acid sequence of SEQ ID NO:19.

9. The laundry detergent composition according to claim 8, wherein said low temperature protease is a subtilisin protease variant comprising an amino acid sequence comprising two, three, or four or more variations versus SEQ ID NO:19 at positions selected from:
(i) 1Q, 3Q/V, 9E/T, 10M, 15I/V, 17H, 19E, 22Y, 24N, 25D, 26R, 27R, 28A, 30T, 35A, 37T, 38G, 43A, 45I/R, 48I, 68S, 71A, 74G, 76K, 77D/H/N/Q/S, 78I, 86H/N/R, 87S/T, 91G, 95A/Q, 96S, 98H/K/R, 99L/S, 100N/R, 102R, 103I, 108H/K, 111Q, 114N, 115F, 120A, 123I, 125N, 126Q, 127F/T, 128P/S, 129T, 130S, 136A/R, 143V, 146A/S, 147L, 151G, 155A/E/G, 160C/R, 165A/E/Q/S, 183A/G, 184Q, 187P, 193D, 202V, 203E/N, 210E/H/P, 217S, 234I/W, 238R/T, 239K/S/T, 240N, 242G, 247W, 250G, 251E, 255R, 258E/H/P, 259P, 260W, and 274A/F;
(ii) 1Q, 3Q/V, 9E, 15I, 22Y, 24N, 28A, 30T, 35A, 37T, 45I, 48I, 68S, 71A, 74G, 76K, 77D/H/N/S, 78I, 86H/N/R, 87S/T, 95A/Q, 96S, 98K, 99L/S, 100N, 108H/K, 114N, 115F, 120A, 123I, 125N, 126Q, 127F/T, 128P/S, 129T, 130S, 143V, 146A/S, 147L, 151G, 155A/E/G, 165A/E/Q/S, 183G, 184Q, 187P, 193D, 202V, 203E/N, 210P, 217S, 234I/W, 238R/T, 239K/S/T, 240N, 242G, 247W, 250G, 255R, 258P, 259P, 260W, and 274A;
(iii) 1Q, 3V, 15I, 35A, 68S, 71A, 77N, 86H, 87S, 95A, 99S, 115F, 123I, 127T, 128P/S, 147L, 155G, 165Q/S, 184Q, 202V, 210P, 217S, 234W, 239S, 242G, 250G, 258P, and 274A; or
(iv) 3V, 68S, 77N, 86H, 99S, 115F, 123I, 127T, 128P, 165Q, 184Q, 202V, 210P, 217S, and 258P.

10. The laundry detergent composition according to claim 8 or 9, wherein said low temperature protease is a subtilisin protease variant comprising an amino acid sequence comprising two, three, or four or more amino acid substitutions selected from:
(i) A/G1Q, T3Q/V, P9E/T, L/Q10M, K15I/V, Q17H, Q19E, K22Y, A24N, N25D, V26R, K27R, G/V28A, I/V30T, I35A, A/S37T, S38G, N/K43A, V45I/R, A48I, A68S, V71A, L74G, N76K, S/T77D/H/N/Q/S, T78I, N/S86H/N/R/S, V87S/T, A/I91G, L95A/Q, N96S, S98H/K/R, G99L/S, S100N/R, S/T102R, Y103I, S108H/K, E111Q, T114N, A/Q/T115F, V120A, M123I, L125N, G126Q, G127F/T, A/P/T128P/S, S129T, G/V130S, Q136A/R, A/S143V, A/I/V146A/S, V147L, A/S151G, S155A/E/G, N/S/Y160C/R, G165A/E/Q/S, G/K/N/S183A/G, N184Q, S187P, A/P/S193D, K194E, A/S202V, G/S203E/N, S/T210E/H/P, S211N, N217S, L234I/W, P238R/T, A/N/T239K/S/T, A242G, D/N/T247W, S250G, R/S251E, N/Y255R, D/S258E/H/P, S259P, F260W, and Q274A/F;
(ii) A/G1Q, T3Q/V, P9E, K15I, K22Y, A24N, G/V28A, I/V30T, I35A, A/S37T, V45I, A48I, A68S, V71A, L74G, N76K, S/T77D/H/N/S, T78I, N/S86H/N/R/S, V87S/T, L95A/Q, N96S, S98K, G99L/S, S100N, S108H/K, T114N, A/Q/T115F, V120A, M123I, L125N, G126Q, G127F/T, A/P/T128P/S, S129T, G/V130S, A/S143V, A/I/V146A/S, V147L, A/S151G, S155A/E/G, G165A/E/Q/S, K/S183G, N184Q, S187P, A/P/S193D, K194E, A/S202V, G/S203E/N, S/T210P, S211N, N217S, L234I/W, P238R/T, A/N/T239K/S/T, A242G, D/N/T247W, S250G, N/Y255R, D/S258P, S259P, F260W, and Q274A;
(iii) A/G1Q, T3V, K15I, 135A, A68S, V71A, S/T77N, N/S86H, V87S, L95A, G99S, A/Q/T115F, M123I, G127T, A/P/T128P/S, V147L, S155G, G165Q/S, N184Q, A/S202V, S/T210P, N217S, L234W, A/N/T239S, A242G, S250G, D/S258P, and Q274A; or
(iv) T3V, A68S, S/T77N, N/S86H, G99S, A/Q/T115F, M123I, G127T, A/T128P, G165Q, N184Q, A/S202V, S/T210P, N217S, and D/S258P.

11. The laundry detergent composition according to any one of claims 8-10, wherein said subtilisin protease variant is from a parent comprising the amino acid sequence of SEQ ID NO:19.

12. The laundry detergent composition according to any preceding claim, wherein said low temperature protease is a subtilisin protease variant comprising an amino acid sequence comprising:
(i) 80%, 85%, 90%, 95%, 96%, 97%, 98%, 99% amino acid sequence identity to the amino acid sequence of SEQ ID NO:18 and two, three, or four or more substitutions selected from positions 22, 68, 76, 101, 103, 104, 106, 116, 120, 159, 188, 167, 170, 194, 195, 232, 235, 245, 248, and 271;
(ii) 80%, 85%, 90%, 95%, 96%, 97%, 98%, 99% amino acid sequence identity to the amino acid sequence of SEQ ID NO:18 and two, three, or four or more substitutions selected from T22A/R, N76D, V68A, S101G, S103A, V104I, S106A, N116L, H120D, G159D, Y167A, R170S, S188D, A194P, G195E, A232V, K235N, Q245R, N248D, and E271F;
(iii) 80%, 85%, 90%, 95%, 96%, 97%, 98%, 99% amino acid sequence identity to the amino acid sequence of SEQ ID NO:17 and two, three, or four or more substitutions selected from positions 24, 33, 53, 76, 78, 97, 101, 109, 128, 217, 243, and 248; or
(iv) 80%, 85%, 90%, 95%, 96%, 97%, 98%, 99% amino acid sequence identity to the amino acid sequence of SEQ ID NO:17 and two, three, or four or more substitutions selected from S24G, S33T, S53G, N76D, S78N, G97A, S101N, N109G, G128A/S, Y217L/Q, N243V, and S248A; and wherein the amino acid positions of the said subtilisin protease variant are numbered by correspondence with the amino acid sequence of SEQ ID NO:17.

13. The laundry detergent composition according to any preceding claim, wherein said laundry detergent composition comprises a low temperature amylase.

14. The laundry detergent composition according to any preceding claim, wherein said laundry detergent composition comprises a low temperature protease.

15. The laundry detergent composition according to any preceding claim, wherein the mannanase variant or recombinant polypeptide or active fragment thereof is derived from a reference polypeptide, wherein said reference polypeptide is selected from SEQ ID NOs:1, 11, 12, 13, 14, and 15.

16. The laundry detergent composition according to claim 15, wherein said mannanase variant or recombinant polypeptide or active fragment thereof has at least 59%, 60%, 65%, 70%, 75%, 80%, 81%, 82%, 83%, 84%, 85%, 86%, 87%, 88%, 89%0, 90%, 91%, 92%, 93%, 94%, 95%, 96%, 97%, 98%, or 99% amino acid sequence identity with the amino acid sequence of said reference polypeptide.

17. The laundry detergent composition according to any preceding claim, wherein the low temperature mannanase is a mannanase that demonstrates at least 1.2, 1.5, or 2 times the relative activity of a reference mannanse at (i) 16° C. when compared to the relative activity at 32° C., or (ii) 20° C. when compared to the relative activity at 40° C.; wherein the reference manannase is set forth as SEQ ID NO:16; and wherein the relative activity is the ratio of the activity of the mannanase and reference mannanase at (i) 16° C. and 32° C., or (ii) 20° C. and 40° C.

18. The laundry detergent composition according to any preceding claim, wherein the low temperature amylase is an amylase that demonstrates at least 1.2, 1.5, or 2 times the relative activity of a reference amylase at (i) 16° C. when compared to the relative activity at 32° C., or (ii) 20° C. when compared to the relative activity at 40° C.; wherein the reference amylase is set forth as SEQ ID NO:7; and wherein the relative activity is the ratio of the activity of the amylase and reference amylase at (i) 16° C. and 32° C., or (ii) 20° C. and 40° C.

19. The laundry detergent composition according to any preceding claim, wherein the low temperature protease is a subtilisin protease that demonstrates at least 1.2, 1.5, or 2 times the relative activity of a reference protease at (i) 16° C. when compared to the relative activity at 32° C., or (ii) 20° C. when compared to the relative activity at 40° C.; wherein the reference protease is set forth as SEQ ID NO:17, SEQ ID NO:18, or SEQ ID NO:19; and wherein the relative activity is the ratio of the activity of the subtilisin protease and reference protease at (i) 16° C. and 32° C., or (ii) 20° C. and 40° C.

20. The laundry detergent composition according to any preceding claim further comprising: at least one surfactant; at least one ion selected from calcium and zinc; at least one adjunct ingredient; at least one enzyme stabilizer; and/or at least one additional enzyme or enzyme derivative selected from acyl transferases, amylases, alpha-amylases, beta-amylases, alpha-galactosidases, arabinases, arabinosidases, aryl esterases, beta-galactosidases, beta-glucanases, carrageenases, catalases, cellobiohydrolases, cellulases, chondroitinases, cutinases, endo-beta-1, 4-glucanases, endo-beta-mannanases, exo-beta-mannanases, esterases, exo-mannanases, galactanases, glucoamylases, hemicellulases, hyaluronidases, keratinases, laccases, lactases, ligninases, lipases, lipolytic enzymes, lipoxygenases, mannanases, oxidases, pectate lyases, pectin acetyl esterases, pectin degrading enzyme, pentosanases, perhydrolases, peroxidases, phenoloxidases, phosphatases, phospholipases, phytases, polygalacturonases, proteases, pullulanases, reductases, rhamnogalacturonases, beta-glucanases, tannases, transglutaminases, xylan acetyl-esterases, xylanases, xyloglucanases, xylosidases, metalloproteases, and a combination thereof.

21. The laundry detergent composition of any preceding claim, wherein said composition is in a form selected from a liquid, a powder, a granulated solid, a tablet, a sheet, and a unit dose.

22. The laundry detergent composition of any preceding claim, wherein said composition contains phosphate or is phosphate-free and/or contains boron or is substantially free of boron.

23. The laundry detergent composition of any preceding claim, wherein said low temperature mannanase works in synergy with said low temperature amylase and/or said low temperature protease to hydrolyze a stain and/or soil.

24. A method of cleaning comprising contacting an item comprising a soil or stain with the laundry detergent composition of any preceding claim, wherein said soil or stain is hydrolyzed.

25. The method of claim 24, wherein said item is a fabric.
